(19) United States
(12) Patent Application Publication
(10) Pub. No.: US 2013/0268422 A1
(43) Pub. Date: Oct. 10, 2013

(54) Tabs Based Drag and Drop Graphical Trading Interface

(71) Applicant: PRANIL RAM, (US)

(72) Inventors: PRANIL RAM, MAKATI CITY (PH); CRISPIN M. ALMODOVAR, SINGAPORE (SG)

(73) Assignee: PRANIL RAM, MAKATI CITY (PH)

(21) Appl. No.: 13/751,191

(22) Filed: Jan. 28, 2013

Related U.S. Application Data
(63) Continuation of application No. 13/492,875, filed on Jun. 10, 2012, now abandoned.
Application No. 13/492,875 is a continuation of application No. 13/151,393, filed on Jun. 2, 2011, now abandoned.
Application No. 13/151,393 is a continuation of application No. 12/267,639, filed on Nov. 10, 2008, now abandoned.
Application No. 12/267,639 is a continuation of application No. 11/162,642, filed on Sep. 17, 2005, now abandoned.
Application No. 11/162,642 is a continuation-in-part of application No. 09/897,437, filed on Jul. 3, 2001, now abandoned.
Application No. 09/897,437 is a continuation-in-part of application No. 09/892,891, filed on Jun. 28, 2001, now abandoned.
Application No. 09/892,891 is a continuation-in-part of application No. PCT/CA03/01377, filed on Sep. 9, 2003.
(60) Provisional application No. 60/610,522, filed on Sep. 17, 2004.

(30) Foreign Application Priority Data
Sep. 12, 2002 (CA) CA2403300
Sep. 9, 2003 (CA) PCT/CA03/01377

(51) Int. Cl. G06Q 40/04

(52) U.S. Cl. CPC G06Q 40/04
USPC 705/37

(57) ABSTRACT

The interface comprises one or more grids, each grid typically associated with a specific security. GUI objects or icons representing orders of a specific quantity may be dragged and dropped onto the grid to place, change, or cancel orders. The Grids are contained within tab pages, which are further contained as tab sets. Status icons are used to represent open, filled, and cancelled orders. The Icon Locate and Order locate feature allows orders on the Grid and Icons in the status panels to be easily associated and cross referenced by a visual indication. Status Icons may be stamped with their associated order type, quantity, trading symbol, and or status. Similarly, the status icons may take the form of corporate logos and adjust in size according to the value or quantity of a position. An Icon packing feature allows status icons to be efficiently placed within their total panel area such that the status icons are visible to the user. Advertising content may be displayed on the trading interface main window and also conveniently packaged within any tabpage or panel.

This application is a continuation of and claims priority to U.S. patent application Ser. No. 13/492,875 entitled, “Tabs based drag and drop graphical trading interface,” filed on Jun. 10, 2012 which is a continuation of and claims priority to U.S. patent application Ser. No. 13/151,393 filed on Jun. 2, 2011 which is a continuation of and claims priority to U.S. patent application Ser. No. 12/267,639 filed on Nov. 10, 2008 which is a continuation of and claims priority to U.S. patent application Ser. No. 11/162,642 filed on Sep. 17, 2005 which claims priority to U.S. provisional patent appl'n Ser. No. 60/610,522 filed Sep. 17, 2004 and is a continuation-in-part of U.S. patent application Ser. No. 09/892,891 filed Jun. 28, 2001, U.S. patent application Ser. No. 09/897,437 filed Jul. 3, 2001, and Int. Appl'n No. PCT/CA03/01 377 filed Sep. 9, 2003 which entered the US national phase as U.S. Ser. No. 10/527,400 and claims priority to CA 2,403,300 filed Sep. 12, 2002, the entire contents of which are incorporated herein by reference.

### BACKGROUND OF THE INVENTION

1. Field of the Invention

This invention relates generally to graphical user interfaces, and more particularly, to graphical user interfaces for buying and selling items such as securities and for facilitating such transactions.

2. Background

There are a number of trading systems, and a number of individuals, who engage in real time day-to-day or minute-to-minute security trading. Very often, such individuals are referred to as day traders.

Moreover, many stock brokers have an interest or duty to observe the dynamics of the market, including price fluctuations and volume of trading in any security.

However, even some proprietary software which is available for use by such individuals as day traders and stock brokers may require considerable key stroke input, and may not provide a dynamic display which indicates not only current market conditions but, by being observed over a period of time, such dynamic display would indicate what the market is doing with respect to a particular security. For example, Bank of Montreal Investorline™ requires that a user shall first enter the ticker symbol for a selected security, then enter the price, then the number of shares, and finally click on a confirmation button. As will be explained hereafter, the present invention permits the user to effectively drag and drop an icon representing at least one selected security, with a selected trading order, over a grid to a selected cell having a selected price, and dropping the icon so as to effect the desired trading order.

Graphical displays in keeping with the present invention will indicate whether the market is moving up or down, whether there is a high volume or low volume of trades occurring at the present time, and even the number of buy or sell orders that may be in place, and at what price, as they may be handled by any market participant.

The trader to whom the present invention is particularly directed is usually, but not necessarily, a sophisticated trader, who is interested in the dynamics of the market, and who is interested in obtaining data for any selected security at any instant in time, as well as to watch the changes in market conditions as they may affect that security over a period of time.

The present invention provides means, including particularly a graphical user interface, to permit the trader to achieve the goals set forth above.

While the present invention is particularly directed to a graphical trading system for use in trading securities, it necessarily includes all of the appropriate physical architecture and logical architecture at least, in functional terms that are necessarily order to facilitate operation of the present invention.

Of course, it will be understood that the present invention contemplates the existence throughout the network of traders and market participants, of secure and high speed communications channels, and of sufficiently powerful and high speed computer hardware to function appropriately and to assure seamless and transparent functionality and operation of the market overview and security trading functionalities of the present invention. The present invention also contemplates that proprietary software which embodies features, functions, and particulars of the teachings herein, will be resident in any computer hardware at the site of any trader practicing or operating this invention.

### SUMMARY OF THE INVENTION

The present invention provides a tabs based drag and drop graphical trading interface for use by any trader who engages in trading securities through established security trading markets, in essentially real time. The system comprises one or more grids where GUI objects or icons representing orders may be dragged and dropped to place, change, or cancel orders.

The Grid is made up of an arrangement of cells. Each cell is associated with a price or range of prices. A handgrab feature allows the Grid and its associated price axis to move up and down. The price axis of the grid can also be centered by double-clicking on the price axis. A method of identifying crossed markets in a visually distinct manner on the grid is disclosed.

The graphical trading interface is adapted to establish a connection with any backend system used by any market participant through suitable communication channels.

The graphical trading interface is available through a computer at each participating trader's site. The interface supports multiple tabsets each of which contains at least one tabpage. The tabpages typically contain a grid associated with a specific security. Tabpages may be organized or moved by drag and dropping said tabpages within tabsets, between tabsets, and by drag and dropping them to a new location to create a new tabset.

Status icons are used to represent the status of open, filled, and cancelled orders. The Icon Locate and Order locate feature allows orders on the Grid and Icons in the status panels to be easily referenced. Status Icons may be stamped with their associated order type or status. Similarly, the status icons may take the form of Corporate logos and adjust in size according to the value or quantity of a position. An Icon packing feature allows status icons to be efficiently located and visible to the user within their respective status panels. Thus reducing the possibility of icons representing open orders or filled orders from being overlooked.

A Replay feature is used to record and playback historical trading activity on a Grid. Typically, the time duration of the animation is accelerated. Advertising content may be displayed on the trading interface and conveniently packaged within tabsets. Other programs and their associated data may be packaged within tabpages to provide a trader with relevant tools necessary for researching, analyzing, and planning securities trades.

### BRIEF DESCRIPTION OF THE DRAWINGS

FIG. 1 shows a block diagram of the trading grid as a software object.

FIG. 2 is a block diagram of the software architecture of a front-end application.

FIG. 3 shows a representation of a tabs based drag and drop graphical trading interface of the present invention as presented and viewed on a display device.

FIGS. 4-7 show various aspects of the interface's Order Locate and Icon Locate feature used to cross reference Icons on the Status panels with Orders on the Grid.

FIG. 8 shows an example of the Holdings Order Locate feature.

FIG. 9 shows an example of the Icon Locate feature when multiple open orders are present at one cell location on the Grid.

FIG. 10 shows data typically found on the holdings tab displayed in icon view.

FIG. 11 shows a trading interface with two tabsets.

FIG. 12 shows a trading interface with two tabsets, wherein one tabset shows a market maker column expanded to show each price point in 1 cent increments.

FIG. 13 shows a trading interface with two tabsets, wherein one tabset shows two market maker columns expanded to show each price point in 1 cent increments.

FIG. 14 shows a trading interface with two tabsets, and depicts the user action of placing a tab into a new tabset.

FIG. 15 shows a trading interface wherein a new tabset in created in the middle of the original two tabsets shown in FIG. 11.

FIGS. 16-18 show the Replay Feature configuration settings panel of the interface.

FIG. 19 is a representation of the Replay Feature playback tabpage.

FIGS. 20-27 are representations of market data, news, and research content directed to the users of the interface.

FIG. 28 is a representation of an online chat tab page as it may be implemented on the interface.

FIG. 29 is a representation of a market analysis tabpage as it may be presented on the interface.

FIGS. 30-32 is a representation of multimedia program, a word processing program, and a spreadsheet program as it may be implemented on the interface.

FIGS. 33-35 are representations of targeted services directed to the users of the interface.

FIGS. 36-40 are representations of targeted advertisements directed to the users of the interface.

FIGS. 41-46 show how the Icon Packing feature is implemented.

FIGS. 47A and 47B show corporate logos used as status icons within the status panel area of the interface.

FIGS. 48A and 48B show status icons which are stamped as to their order type.

FIGS. 49 and 50 show a crossed market situation on the Grid.

FIG. 51 is representative of the Position Guide Direct Output Settings panel.

FIGS. 52A and 52B illustrate the hand-grab feature used to move the grid and its associated price axis up or down.

FIG. 53A shows an example of advertisements that are displayed to users of software applications that are configured to receive advertisements.

FIG. 53B shows the main window of a trading interface with specific areas highlighted to indicate where advertisements may be displayed.

FIG. 54A shows an example of a scrolling ticker that displays trading-related information.

FIG. 54B shows the main window of a trading interface with specific areas highlighted to indicate where scrolling tickers that show trading-related information may be displayed.

FIG. 55 shows a flowchart depicting an algorithm for the icon packing feature.

FIG. 56 displays a table showing how icon size in the status panels may be proportional to a parameter of the security or trade.

FIG. 57 shows a table with examples of the cell price interval and cell price range options associated with a given cell on the grid.

FIG. 58 shows the architecture of an Ad Targeting System for online trading.

FIG. 59 shows the internal structure of the Advertisement Targeting System.

### DETAILED DESCRIPTION

In this application the following terms shall have the following meanings. The term “item” means anything that can be bought or sold. A primary example of an item is a financial instrument, such as a security, but the present invention comprehends all forms of vendible items such as auction items, tickets, seats, rentals, durable goods, perishable items, collectibles, and the like. The term “transaction conditions” comprehends all forms of transaction defining parameters, including, without limitation, price, market, quantity, total value, commission, currency, terms, order type, and the like. The term “order” typically means data pertaining to a user's bid or offer for a particular item, or an order for a security or auction. Order data includes, without limitation, data regarding the price at which a user will buy, sell, stop, or short an item, the size or quantity of an order, the identity of the user, and the duration that the user's order remains valid. The term “quote” means data pertaining to a quote or an order other than an order of the user of the present invention. Quote data for a specific item typically includes, without limitation, the bid and ask prices, the market and item identifiers, the size or quantity associated with the bid and ask prices, and the like.

As explained in more detail below, transaction conditions can be derived from the position of a user directed moveable icon, or GUI object, on a graphical representation of the market, or markets, for an item. Transaction conditions can also be derived from user selected criteria relating to the transaction, from predetermined criteria held in a database and relating to the user, and from the user's preferences, settings, and the like.

A movable icon is any form of GUI object that can be positioned by a user. Most preferably, according to the present invention a graphical representation is one where the position of the movable or non-movable icon, such as its position in a pricing grid, is directly related to a numerical value, such as a price value, to display to the user, and through a glance, its association with other elements in the pricing grid. A graphical representation comprehends all representations of item information that do not rely solely on the numerical value to convey information, and in particular, are related to some or all of the visible aspects of the trading grid as described herein.

One aspect of the present invention improves on the utility of the traditional Level 2 or ECN quote display by “plotting” bids and asks for a particular security on a two-dimensional grid whose columns are typically labeled with market identifiers, and whose rows are labeled with price values. The grid functions like a mathematical “coordinate system”, wherein the vertical axis represents the range of prices that the security can have, and the horizontal axis represents the markets or market participants that trade in the security. The intersection of a row and a column defines a cell, which represents at least one specific market and at least one specific price level for a security. The price component of a cell may be regarded as a price bin representing at least one distinct price. The market component of a cell may be regarded as a market bin representing at least one distinct market. The grid thus appears as a two-dimensional array of cells resembling a checkerboard. This two-dimensional array of cells serves as the grid's “plotting surface”, where bids, asks, various orders and order types, and other information are plotted. This collection of GUI objects—consisting of the column and row labels and the two-dimensional array of cells—define the “trading grid” referred to henceforth in this document.

On the trading grid, bids and asks are represented by color-coded icons that are plotted on the trading grid's “plotting surface” (i.e. the array of cells). For example, a bid for MSFT on Island ECN at $61.45 is plotted on the cell which is the intersection of the “ISLD” column and the “61.45” row. As the bid and ask prices change dynamically and in real-time, the positions of the color-coded icons change accordingly, to reflect the change in prices graphically and in real-time. As an initial convention, blue rectangular icons represent bids while red rectangular icons represent asks. Additionally, the bid/ask icons can have text labels that show, for example, the size (i.e. the number of shares or lots) or a related market or security statistic available to the user and associated with the bid or ask icon.

Another aspect of present invention allows a user to better comprehend the spatial relationship between quotes in Level 2, or ECN type data, as the display is graphical and the price axis is linear and orderly. Graphical information is comprehended faster than textual information. One advantage of a visual approach of the trading grid over a text-based approach of the traditional Level 2 display employs can be shown by way of an example. In the traditional Level 2 display, the “spread” is not readily apparent and some users may require a calculator to determine it. On the other hand, in the trading grid the “spread” is simply the visual gap between the blue and the red rectangular icons representing the highest bid and the lowest ask prices respectively.

This method of plotting bids and asks on the trading grid is useful to traders, and as such it can replace the traditional method of displaying NASDAQ Level 2 data, ECN market book data, and other detailed quote information. In this configuration, the trading grid is typically implemented as a “software object”, as described in more detail hereafter.

A further aspect of the present invention improves on the utility of graphical quote presentation by also allowing a “drag and drop” method for order placement, order modification, and order cancellation on the graphical display. The trading grid is typically implemented as a component of an application program when this feature is added. However this is not always the case, as it is also possible to add this feature to a “software object” implementation of the trading grid. This application program is henceforth referred to in this document as the “front-end application” or simply “front-end”. Regardless of how the trading grid is implemented, as a software object, or as a front-end application, the user interactivity is essentially identical.

Existing on-line brokerage trading accounts typically use a forms-based approach to allow a client to place an order. These trading systems typically require users to go through the following routine when placing an order: (a) enter the ticker symbol, (b) enter the price, (c) enter the number of shares or lots, and then (d) click on a confirmation button. This approach is also supported by the front-end of the present invention. Additionally, the front-end also allows the trader to use a “drag-and-drop” technique for placing orders. This technique builds on the previously described “checkerboard” metaphor, in that the act of placing, modifying, and canceling an order is likened to the act of moving a checker piece into a position on the checkerboard, or taking the checker piece off of the checkerboard.

A user of the present invention has a number of options when placing a new order using the front-end. One option is to use the order-entry form, in which case the user will need to go through the same routine (for both buy and sell orders) as with existing on-line trading systems. A second option is the drag and drop method of placing a buy order. For example: (a) click on an icon representing cash or a quantity of shares, (b) select the investment amount or the number of shares to be purchased for the buy order (represented by an icon) from a pop-up window or suitable selection means, (c) drag the selected icon representing the buy order to the column associated with the preferred market, (d) select the price of the buy order by positioning the icon on the row representing the desired price level, and (e) drop the icon onto the cell defined by the selected column and row.

For a sell order, the following series of steps is applicable: (a) click on the icon representing an investment or an inventory of a security, (b) adjust the number of shares to be sold (represented by an icon) from a pop-up window or suitable selection means, (c) drag the selected icon representing the sell order to the column associated with the desired market, (d) select the price by positioning the icon on the row representing the desired price level, and (e) drop the icon on to the cell defined by the selected column and row. It should be apparent, that there may be variation in the order of these steps and some steps may be omitted, which would nevertheless, effectively accomplish order entry and order modification.

The options described above result in an order automatically transmitted to the back-end system, and an icon representing the order to be plotted on the trading grid. The order will be plotted on the column representing the specified market, and on the row representing the specified price. As an initial convention, the order icon may be displayed in a Green color to distinguish it from the bid and ask icons.

The method of plotting the trader's order and the current bids and asks (which are already plotted on the trading grid) for a security, is a further aspect of the present invention. This aspect provides the trader with a visual correlation between his orders and the current underlying activity of the market.

The drag-and-drop method is further applied to the procedure for modifying an existing order, and to the procedure for canceling an existing order. For example, to modify (or “change”) an existing order's transaction conditions using the front-end, the user simply needs to select the icon representing the order. It is then dragged either to another column (market) and/or another row (price). To effect the transaction, the user simply drops the icon on the new cell location as defined by the selected row and column. A “change order” instruction is then automatically transmitted to a back-end system by the front-end. The processing and back-end details of the “change order” transaction are transparent to the user.

To cancel an existing order using the front-end, the user simply needs to select the icon representing the order, and then drag and drop it outside the area of the trading grid. An “order cancellation” instruction is then automatically transmitted to a back-end system by the front-end. As with the “change order” transaction, the details of the “order cancellation” transaction are completely transparent to the user. In contrast, for existing trading systems, the procedure for modifying or canceling an existing order typically makes use of the forms-based or a menu driven approach.

As a first preferred embodiment of the present invention, a software object implementing the functionality of the “trading grid” of the foregoing discussion is described. This software object uses an object-oriented design and is implemented using Microsoft Corporation's .NET Framework software platform and the C# programming language. However, the software object can also be implemented using other software design techniques, platform, and programming languages. For example, an alternative implementation may use the Java platform and programming language. Other alternatives include Macromedia's Flash technology, Curl Corporation's Surge platform and Curl programming language, Adobe's Scalable Vector Graphics (SVG) technology, and the like.

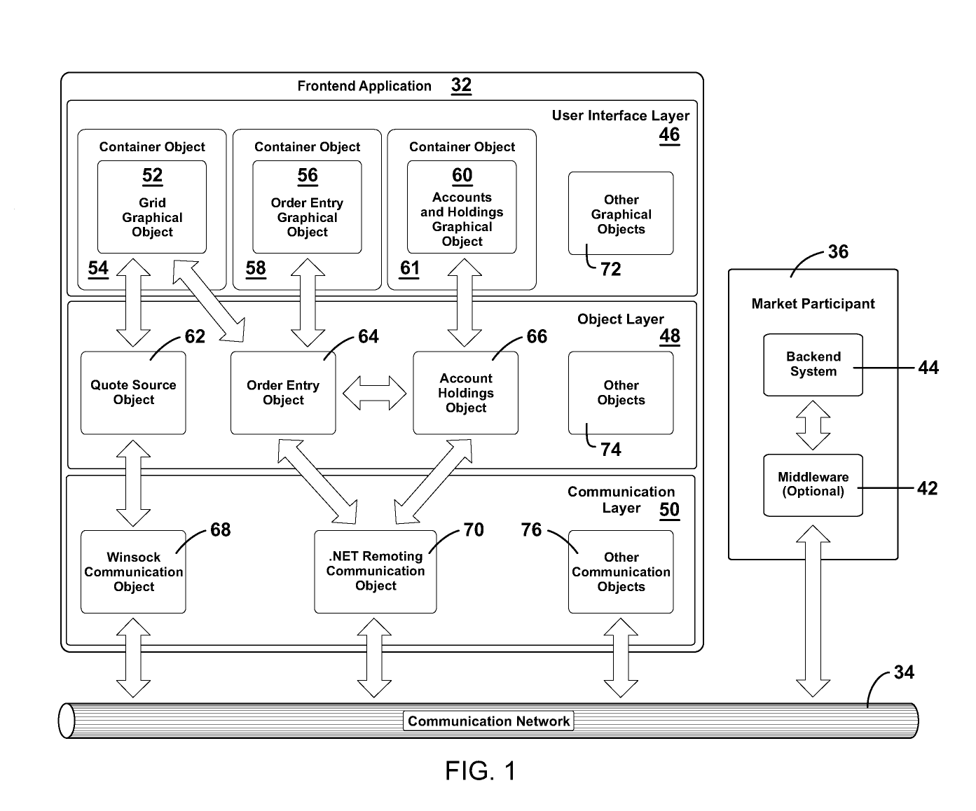

FIG. 1 shows a block diagram of the trading grid as a software object. The software object, as illustrated in FIG. 1, executes on a computer and has two aspects: (1) its visual manifestation 10, which is displayed on the computer screen, and which a user sees and interacts with; and (2) its program logic, which is implemented in computer code. The software object's program logic includes six processes, which the software object employs to accomplish its tasks. However, it is also to be noted that the six processes noted below are only representative of all possible combinations of processes that the software object may employ. The software object's visual manifestation is typically composed of one or more axes associated with dimensions of trading data, a drawing area, and fixed and movable GUI objects (icons, images, geometric shapes). The software object's visual manifestation is where trading data is graphically presented. This graphical presentation can employ several styles. The trading grid of the foregoing discussions corresponds to the software object's visual manifestation 10.

The software object's program logic consists of the following processes: (1) Connect process 12; (2) Retrieve process 14; (3) Transform process 16; (4) Display process 18; (5) Interpret User Input process 20; and (6) Send Instructions/Receive Feedback process 22. The Connect process 12 is used by the software object to establish connections with one or more data sources, 24. This process uses standard communication protocols, such as TCP/IP, to establish a communication link between the software object and a data source. The Retrieve process 14 is used by the software object to receive trading data from a data source 24. This process manages the integrity of the data packets coming from the data source. The Transform process 16 is used by the software object to process the trading data it receives from data sources 24. This process performs data transformation procedures, when necessary, on the trading data received from a data source.

The Display process 18 is used by the software object to plot and render GUI objects, each one representing an order or a quote, on the software object's drawing area 30. This process involves drawing the row headers and column headers; drawing the two-dimensional array of cells; plotting bids and asks using data received from the data source, plotting orders submitted by the user; as well as displaying other related information. The Interpret process 20 is used by the software object to receive and interpret inputs coming from the user. These inputs may be commands to change the graphical properties of the visual manifestation, inputs that request for trading data, or they may be inputs that effect a trading transaction. These inputs typically come from a suitable input device such as a mouse, a trackball, or a keyboard.

The Send Instructions/Receive Feedback process 22 is used by the software object to generate and transmit instructions (such as transaction instructions and requests for trading data), as a result of the user's interaction with specific elements of the software object's visual manifestation. These instructions are sent to the appropriate destination depending on the type of the instruction: for example transaction instructions are sent to a market participant system 26, while requests for trading data are sent to a data source 24. Furthermore this process 22 is responsible for receiving feedback data pertaining to the status of the previously transmitted instructions.

A Data Source 24 is any system that can supply trading data. It can be any or a combination of the following: securities exchanges, stock markets, currency markets, commodities exchanges, electronic communication networks (ECNs), brokerage firms, data feed providers, market simulation software, and trading data published on any suitable media (such as CD-ROM).

A Market Participant System 26 is any system that can receive, validate, route, and possibly execute trading orders. It can be any or a combination of the following: securities exchanges, stock markets, currency markets, commodities exchanges, electronic communication networks (ECNs), brokerage firms, order-entry firms, and market simulation software. Often times, the Data Source 24 and the Market Participant System 26 are one and the same system. This is the case, for example when the Data Source is Island ECN, and the Market Participant System is also Island ECN.

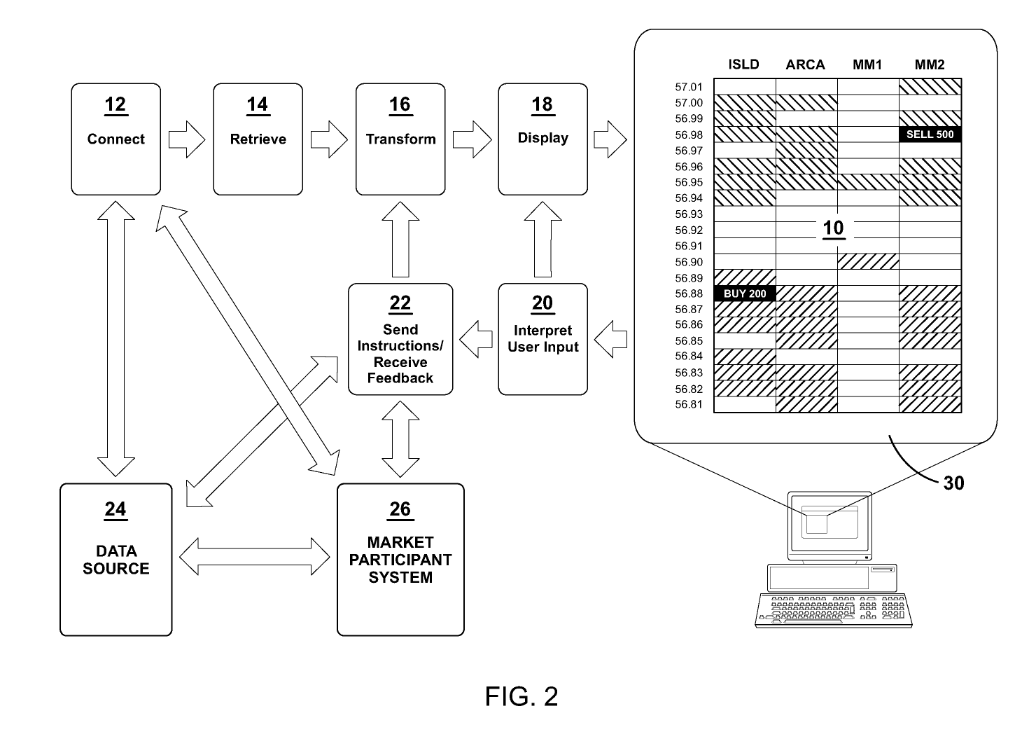

FIG. 2 is a block diagram of the software architecture of a front-end application. FIG. 2 shows the basic software architecture of a second preferred embodiment upon which the methods of the present invention can be practised. Turning now to FIG. 2, the internal architecture of the front-end 32, and the main program therein, is shown in terms of the functional blocks that are operable at the front-end 32.

The front-end 32 consists of a main executable program—which acts as the overall “controller” of the front-end—and several software building blocks called “components” or “objects”. In a Microsoft Windows implementation of the front-end, the main program is a .NET Windows Forms application, and the software components are .NET components. However, in an implementation of the front-end for other operating systems and application platforms, the architecture and the actual technologies used may be different. For example, for a UNIX implementation, the front-end can be a Java Swing application, and the software components can be JavaBeans™ components.

Unlike some monolithic Windows applications, which put together all functionality in a single package, the front-end of the present invention uses the flexibility of Microsoft Corporation's .NET Framework technology to organize functionality into self-contained, reusable software building blocks called “components” or “objects”. (Note: There is a difference between these two terms. A component is made up of one or more objects. However, the two terms are used interchangeably herein.) Each of these components or objects encapsulates distinct software functionality, and interacts with other components through clearly defined programmatic interfaces.

The front-end 32 is similar to conventional Microsoft Windows applications in that it adheres to the visual (e.g. menu structure, status bars, buttons, etc.) and behavioral (e.g. right click behavior, resize behavior, etc.) standards for Windows-based applications. The front-end's main executable program controls and manages the application's various constituent objects. Furthermore the main program coordinates the operation of the objects, by passing messages between itself and the objects.

The core of the front-end however, is in the set of software objects implementing the application's functionality. These software objects fall into two categories: (1) graphical objects, and (2) non-graphical objects. Both types of objects encapsulate software functionality, but the graphical objects also display a visual interface. In .NET Framework terminology, these graphical objects are called “Windows Forms custom controls”, while the non-graphical objects are called “.NET components”. The software objects are grouped together, according to functionality, into “layers”. As noted above, there are three layers: (1) the user interface layer 46, (2) the object layer 48, and (3) the communication layer 50.

An important software object is the grid graphical object 52. It plots trading data on a two-dimensional array of cells, which it draws dynamically. The grid graphical object receives its data in real-time (or close to real-time) from a source of information such as a quote server (not shown) which resides on the back-end 44; the data however, passes through the object layer 48 and the communication layer 50 first. The grid graphical object 52 also implements the graphical placement and modification of orders using a “drag-and-drop” method.

The grid graphical object 52 is hosted inside a container object 54, to facilitate the grouping of multiple instances of the grid graphical object, discussed hereafter. The container object 54 is a graphical user interface (GUI) element with the capability to “contain” other graphical objects. An example of a container object is a tab-based dialog object common in Microsoft Windows-based applications.

The order entry graphical object 56 is a compound object (i.e. object made up of several smaller objects) which users of the front-end interact with to post and modify an order (and its associated parameters). The order entry graphical object 56 is also hosted inside a container object 58. The account and holdings graphical object 60 is another compound object that displays summary and detailed information about an account. This information includes the account balance, order status, account summary, etc. The account and holdings graphical object 60 is also hosted inside a container object 61.

An object layer 48 is shown which groups together components that perform business logic, and components that implement utility functions. The components in this layer: (1) validate users' actions performed on objects belonging to the user interface layer 46; (2) translate users' actions into commands, if applicable, to be sent to any appropriate back-end system via the communication layer 50; and (3) process return values, notification messages, transaction receipts, or confirmations or any other data sent by the back-end system through the communication layer 50. The object layer 48 serves as an abstraction layer that shields the user interface layer 46 from the implementation of the lower level communication layer 50.

Each of the graphical objects in the user interface layer 46 described can have a counterpart object in the object layer 48. The grid graphical object 52 has a quote source object counterpart 62, which encapsulates the logic necessary for requesting and receiving trading data such as NASDAQ Level 2 data, from the back-end system. The order entry graphical object 56 has an order entry object counterpart 64, which implements the logic and business rules necessary for posting buy, sell, change, cancel, and other types of orders to the back-end system, via the optional middleware 42. The account and holdings graphical object 60 has an account and holdings object counterpart 66, which implements the logic necessary for requesting, receiving, and updating account information from the back-end system.

The communication layer 50 consists of components that act as communication “gateways” between the front-end and a back-end system 44. The communication layer 50 translates messages coming from the object layer into the format required by the back-end system. That translation may be into .NET Remoting messages, but any suitable option for facilitating communication may be chosen. It is to be noted that although .NET Remoting is the primary protocol for main program 32 to middleware 42, communication, other suitable protocols such as Simple Object Access Protocol (SOAP) and Winsock can also be employed.

The communication layer 50 has one or more objects that implement the logic involved in translating requests and commands coming from the upper layers 46 & 48 of the front-end 32 into the format expected by the back-end system through the optional middleware 42. The communication objects also translate the data coming from the back-end system 44, through the optional middleware 42, into the format expected by the objects in the upper layers of the front-end 32. In FIG. 2, there are two communication objects: the Winsock communication object 68, which implements the logic for remote communication using the Microsoft Windows implementation of the Berkeley Software Distribution (BSD) Sockets protocol, and the .NET Remoting communication object 70, which implements the logic necessary for remote communication using the .NET Remoting protocol.

The communication layer 50 is designed to accommodate the “plug-and-play” addition and removal of communication components, each component implementing a specific type of communication protocol (e.g. .NET Remoting, SOAP, Winsock) for interfacing with the back-end system 44 through Communication Network 34. A market participant 36 manages the operation of the back-end system 44 and the optional middleware 42.

It will now be seen that the front-end 32 is an important second embodiment of the present invention, as it provides a graphically intuitive, fast, user-friendly application that any trader may use in order to get stock or other security quotes, manage their account with their respective brokerage firm or other market participant, place, modify, or cancel securities orders, track the status of those transactions, and track their current account status vis-à-vis any selected security, their cash position, and so on. Typically, the front-end 32 operates on a Windows® platform, but not necessarily. Other platforms may also be employed, such as UNIX and Macintosh.

As will be discussed hereafter, the graphical display employs GUI objects to display trading data in a dynamic fashion, very intuitively, and allows the trader to buy, sell, modify or cancel securities orders, by interacting with the front-end using any suitable pointing device, such as mouse, to drag and drop GUI objects onto the trading grid. Other objects 72, 74, 76 may be found on each of the respective user interface layer 46, object layer 48, and communication layer 50, as may be determined by a skilled programmer who is familiar with the technology and features of the present invention.

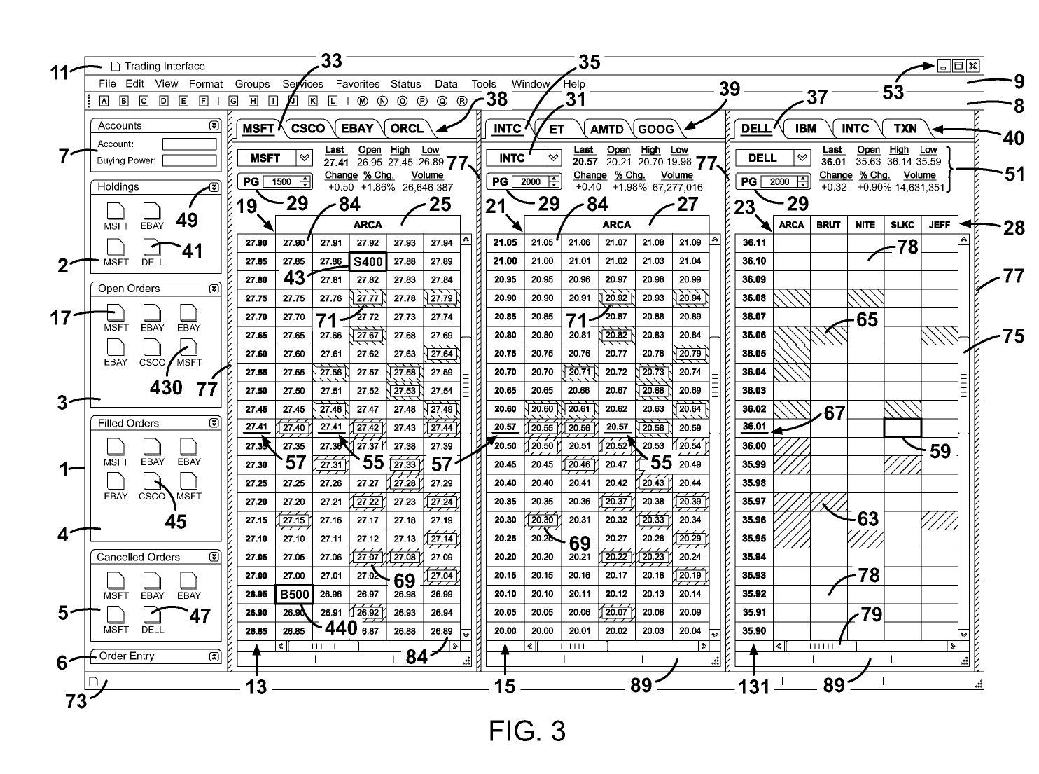

FIG. 3 shows a representation of a tabs based drag and drop graphical trading interface of the present invention as presented and viewed on a display device. FIG. 3 shows the main window 1, an application title bar 11, menu bar 9, toolbar 8, Accounts panel 7, Holdings status panel 2, Open Orders status panel 3, Filled Orders status panel 4, Cancelled Orders status panel 5, Order Entry panel 6, status bar 73, first tabset 38 showing first active tabpage 33, second tabset 39 showing second active tabpage 35, third tabset 40 showing third active tabpage 37, tabset separator bars 77, status icons 41, 17, 430, 45, 47 for a variety of buy, sell, and short order types, and open order cell representations 43, 440 plotted on the graphical trading grid associated with specific tabpages and securities.

Each of first, second, and third active tabpages contains a symbol input text box 31, a PG icon 29 with a displayed quantity recommendation, basic level 1 style quote data 51, a graphical trading grid 19 in the first active tabpage 33, 21 in the second active tabpage 35, and 23 in the third active tabpage 37. Each graphical trading grid has its associated price axis 13, 15, 131 respectively, market “MMID” header data 25, 27, 28 respectively, horizontal and vertical scroll bars 75, 79, and open order representations 69, 71, 63, 65 of various orders plotted on the graphical trading grid.

The price range indicated on the price axis may be stationary or move to automatically center the trading activity shown on the trading grid. Similarly, a double-click on the price axis or its surrounding area may re-center the price axis price range to that of the trading activity or last trade of the security displayed on the grid.

The last trade price 57, 67 for a security is visually indicated (for example by means of underlined text labels) on the nominal price axis. The last trade price 55, 59 can also be visually indicated on the graphical trading grid by means of underlined text labels or by means of highlighting the border of the relevant cell in the graphical trading grid.

Orders are represented graphically as cells on a trading grid and as icons in a status panel. For example, icons may represent open, filled, partially filled, or cancelled orders and holdings icons. To cancel an order the order is merely dragged off its trading grid. To change and order or market or both, the order is merely dragged and dropped to a new price point or market or both. The cells of the trading grid may have price labels as in 84, or they may not have price labels as in 78.

An icon representing an open order may also be dragged and dropped to a location on the grid to effect a change in the price or market of its associated order cell. If an icon is present in any of the various icon panels, such as the holdings, open orders, filled orders, or cancelled orders panel, it may be double clicked to populate a tabpage with its associated underlying security. If the Icon's tabpage is already present, it will become the active tabpage when its Icon is double-clicked or some similar action. If the Icon's associated tabpage is present but not visible or only the tab is visible, a double-click of its associated icon it will move to the foreground and become the active tabpage of its tabset.

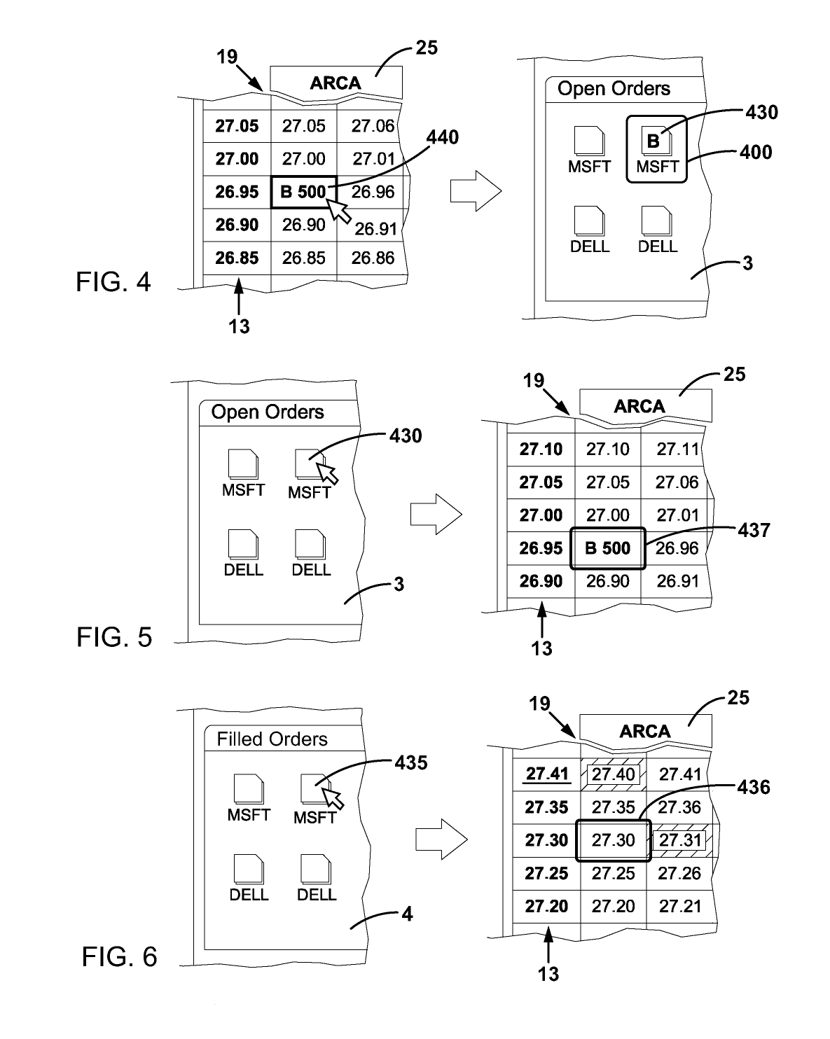

FIGS. 4-7 show various aspects of the interface's Order Locate and Icon Locate feature used to cross reference Icons on the Status panels with Orders on the Grid. The Icon locate feature is used to locate an Icon on the Status Panel associated with an order on the Grid. The Order locate feature is used to locate an Order on the Grid associated with a Status Icon in one of the Status Panels. Generally, when it comes to orders and iconic representations of orders, the term “Order” is used when the GUI object representing an order is located on the Grid. The term “Status Icon” is used when the GUI object representing the order is located in the Various Status Panels to the left of the main window 1.

FIG. 4 shows an example of the Icon Locate feature. An open limit order 440 on the grid 19 is shown. The order 440 is a buy order for 500 shares of MSFT at 26.95. When the user moves his mouse (cursor) to the grid order and right-clicks on the order 440 to select “Icon locate” from the pop-up menu (or the middle button on the mousewheel may be programmed for such a use) for Icon Locate, then a border 400 is painted around the Status Icon 430 in the open order status panel 3. Thus, the user has identified which Status Panel Icon is associated with the Open order 440 on the trading grid 19.

FIG. 5 shows an example of the Order Locate feature. Multiple Icons may be present on the open orders status panel 3. When the mouse cursor is used to right-click on a status icon 430 and select “order locate” from the pop-up menu item (or the middle button on the mousewheel may be programmed for “Order Locate” use), then a border 437 is painted around the order (this order is the same grid order 440 shown in FIG. 4 to buy 500 shares of MSFT at 26.95) on the trading grid 19. associated with the Security's Icon 430 on the open orders panel 3. Thus, the user has identified which grid open order icon is associated with the Status icon 430 on the Open Orders Status panel 3. As shown in FIGS. 4 and 5, the user of the interface can associate open orders present on the grid 19 to open order status icons present in the open orders status panel 3. This is especially helpful if the user has multiple orders in the status panel area or on each grid.

FIG. 6 shows an example of the Filled Order Locate feature. A Status Icon 435 in the filled orders status panel 4 may be clicked with a mouse to find the location on the grid 19 where the order was filled. In this example, the filled status icon 435 is seen to be filled at 27.30 in the ARCA 25 market. The price at which the order was filled is shown by a border 436 around the cell on the ARCA grid 19. If a Filled status icon represents fills at multiple locations (for example if it was a large market order), then multiple cell locations on the grid will show the applied border pattern or similar visual or graphical feature. Thus the user can reference in a convenient manner, where his orders were filled on the grid. If the price or cell is not visible, the grid will move to display the correct location of the filled or open order on the grid. Similarly, if the market associated with the order is not visible, it will become visible before the cell location at which the fill occured or open order exists is distinguished.

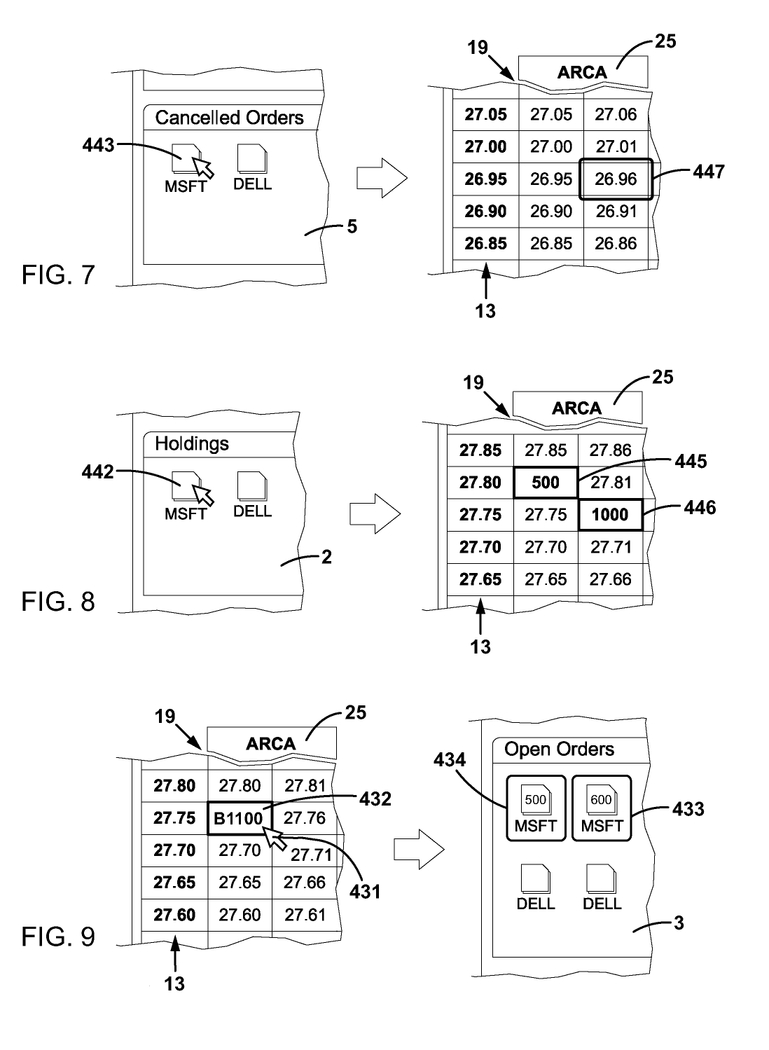

FIG. 7 shows an example of the Cancelled Order Locate feature. Cancelled status Icons 443 may be clicked to find the location on the grid 19 where the order was cancelled. A border 447 is applied around the cell on the grid 19 where the order existed prior to being cancelled. Orders on the grid may be cancelled by dragging and dropping them off the grid or the grid's associated tab page. Similarly, the status icon can be dragged and dropped into a trash can icon located on the interface. An order may also be cancelled by right-clicking or middle button clicking on the status icon or order icon on the grid and selecting the cancel command. The order may also be cancelled by selecting it and cancelling the order through the order entry panel 6.

FIG. 8 shows an example of the Holdings Order Locate feature. A security's holdings status Icon 442 may be clicked to identify on the grid, the cell locations where the various orders comprising the security's inventory were filled. This information may also be presented on a pop up list if the various fill data is too diverse and involve wide price ranges and orders which were filled in multiple markets. On FIG. 8, the holding status icon 442, is shown to be filled at two locations on the grid 19. A border 445, 446, and the quantity associated with each fill (or each price) is shown as a text label within the cell.

FIG. 9 shows an example of the Icon Locate feature when multiple open orders are present at one cell location on the Grid 19. The order or cell 432 may be clicked with a cursor 431 to find the various status icon locations in the open orders Status Panel where the open order icons are located. A border is painted around each open order icon 434, 433 in the status panel which is associated with the cell 432 and its open orders on the grid 19. Orders that were cancelled or filled at the same cell location may also have their respective icons indicated in the status panel area.

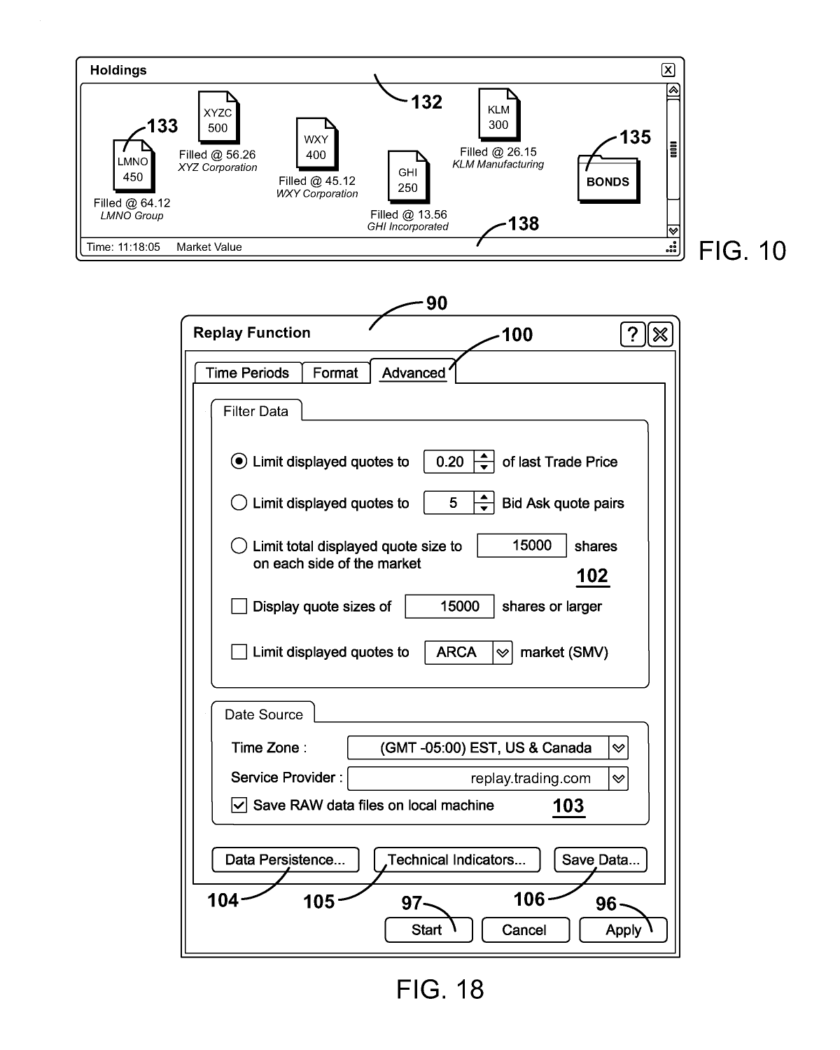

Turning now to FIG. 10. FIG. 10 shows data typically found on the holdings tab displayed in icon view. A Holdings panel is shown with separate icons for each position in a given security. The significance is that an icon representing a security holding can be dragged and dropped into its associated trading grid to effect a sell order. Likewise, any of the holding icons 133 shown in FIG. 10 can be dragged and dropped onto their respective Trading Grid. Security holdings, open orders, and the like may be categorized and grouped in status panels. For example, folder icon 135 may contain details of the user's bond holdings.

Examination of FIG. 10 shows that 500 shares of XYZ Corporation are held in the user's portfolio; that they were purchased at 56.26. The icons shown in FIG. 10 may be colored so as to show the type of security, the type of order that exists, the size of the order, or the profit or loss amount associated with the investment. For example, one color may be used to represent a short order, another color used to represent an option, or a margin purchase, or to indicate a profit or loss on individual positions. Each icon may further have data associated with it that may be revealed by holding a pointing device's cursor over the icon. The status bar 138 may also display data, as well as the current market price for the security if elected.

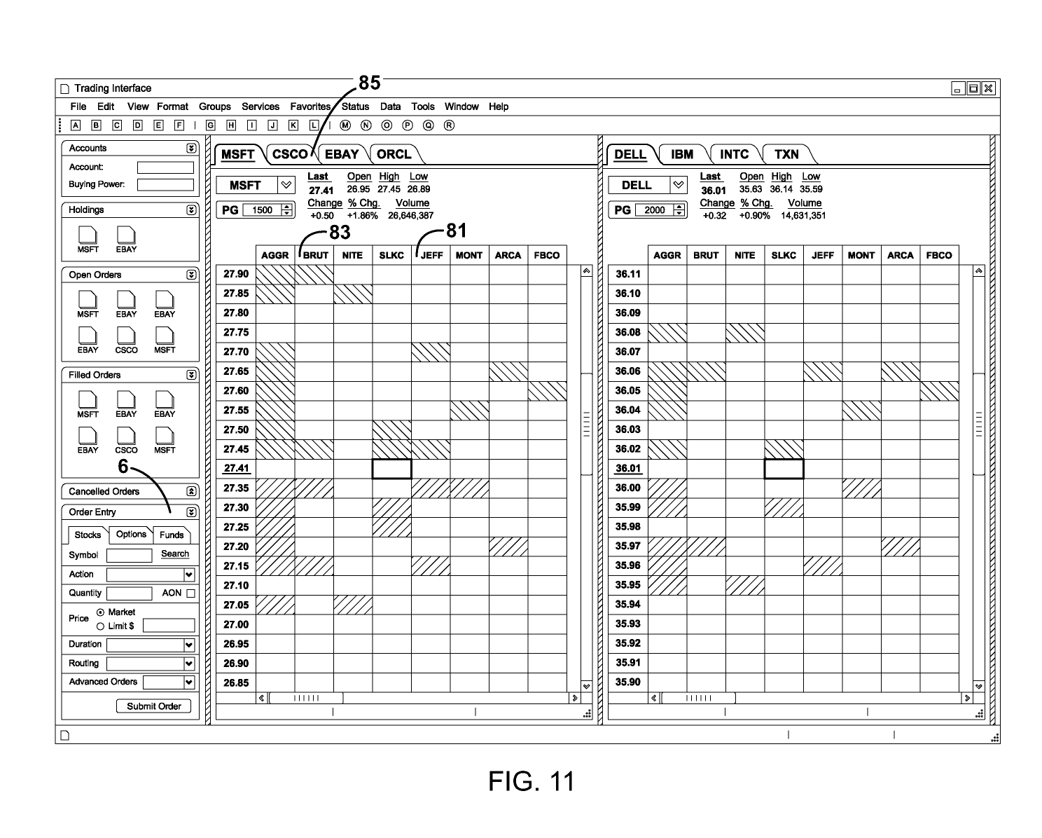

FIG. 11 shows a trading interface with two tabsets and various panels representing Accounts, Holdings, Open Orders, Filled Orders, Cancelled Orders, and an Order Entry panel. The Accounts, Holdings, Open Orders, Filled Orders, and Order Entry panels are all in the expanded state, while the Cancelled Orders panel is in the collapsed state. The MSFT tab is active on the left most tabset. To the right of the MSFT tab, a CSCO tab 85 is shown. Also shown are a BRUT MMID column header 83 and a JEFF MMID column header 81. Note that the price axis increments in 5 cent increments.

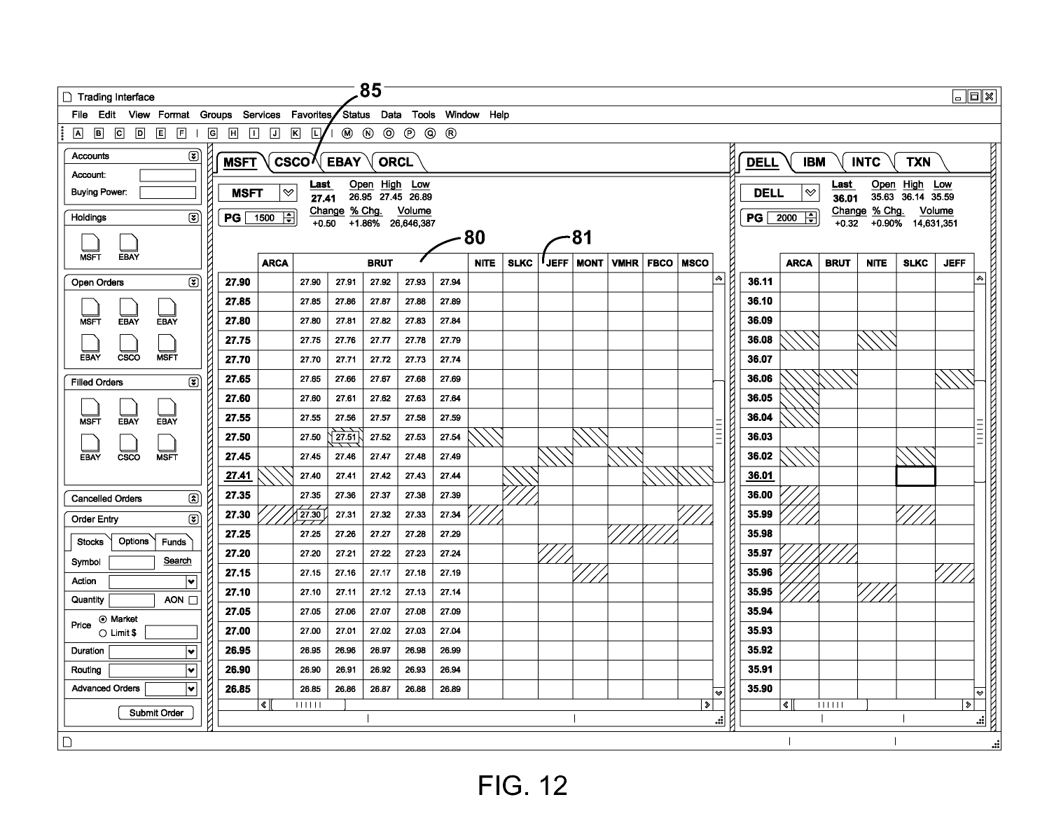

FIG. 12 shows a trading interface with two tabsets and various panels representing Accounts, Holdings, Open Orders, Filled Orders, Cancelled Orders, and an Order Entry panel. The MSFT tab is active on the left most tabset, and to the right of the MSFT tab is a CSCO tab 85. When the BRUT MMID column header 83 is double clicked, the column expands 80 to show each price point in 1 cent increments. Note that the price axis increments in 5 cent increments and without some means to place an order on the trading grid to the nearest 1 cent, each order would be placed at a default value indicated by the price axis. The expanded column 80 allows for the precise selection of order price down to the nearest 1 cent.

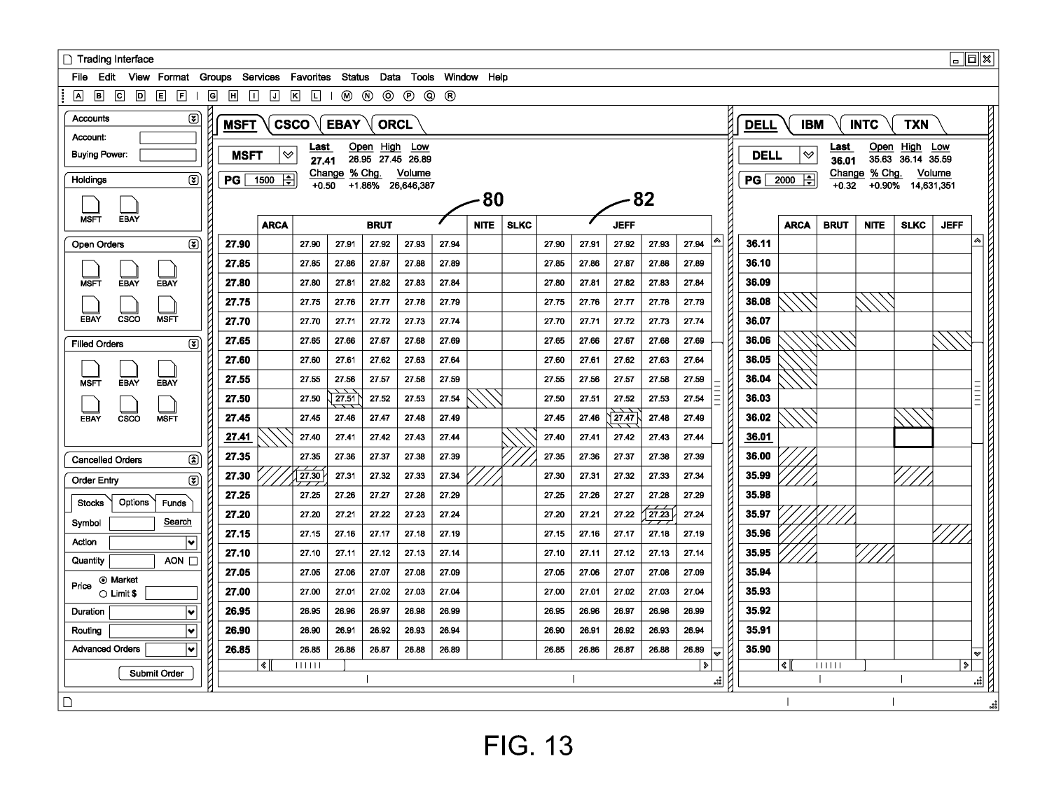

FIG. 13 shows a trading interface with two tabsets and various panels representing Accounts, Holdings, Open Orders, Filled Orders, Cancelled Orders, and an Order Entry panel. The BRUT MMID column header 80 is expanded to show each price point in 1 cent increments. Note that the price axis increments in 5 cent increments. When the JEFF MMID column header 81 is double clicked, the column expands 82 to show each price point in 1 cent increments for more precise order placement. When the price axis for the given trading grid increments in step values such as 5 cents, or 10 cents and trading is permitted between the step values, expanding market maker columns permit more precise order placement or order changes.

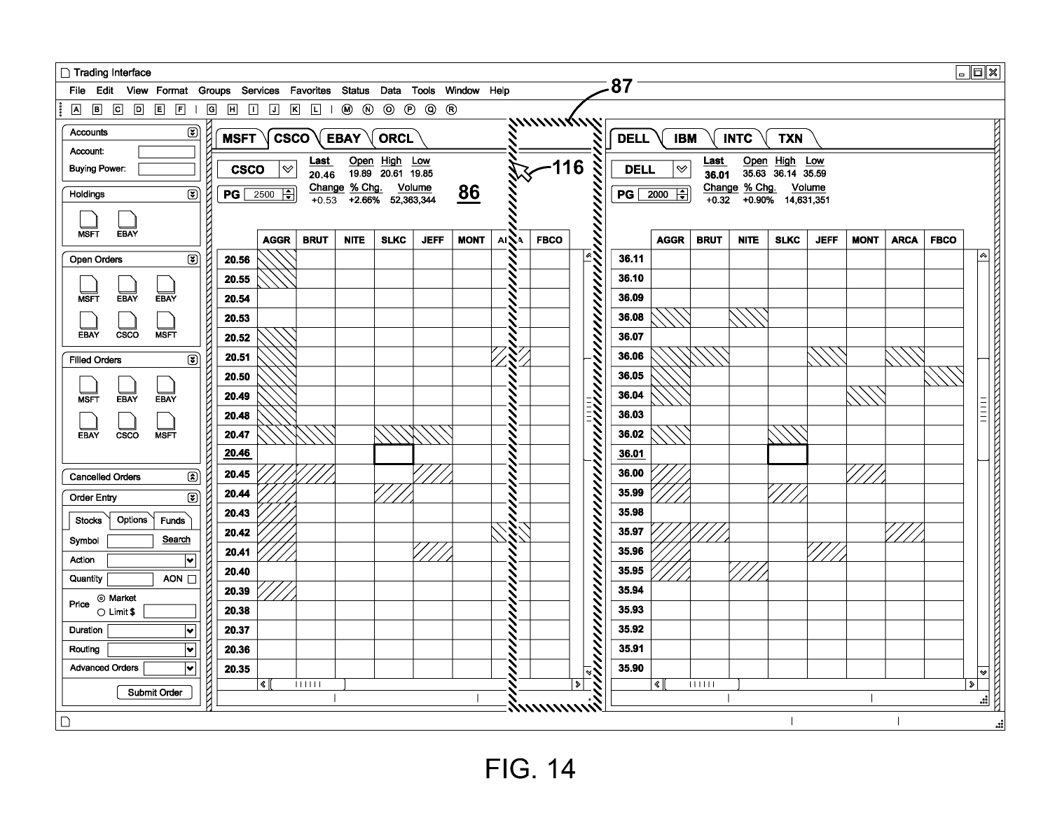

FIG. 14 shows a trading interface with two tabsets and several panels, similar to that shown in FIG. 11. However, in FIG. 14, the user action of placing the CSCO tab into a new tabset is depicted. The user clicks on the CSCO tab 85 to make it the active tab 86 on the tabset and then drags the CSCO tab to the location indicated by the visual target box indicator 87 next to the mouse cursor 116, and then drops the tab at that location to create a new tabset.

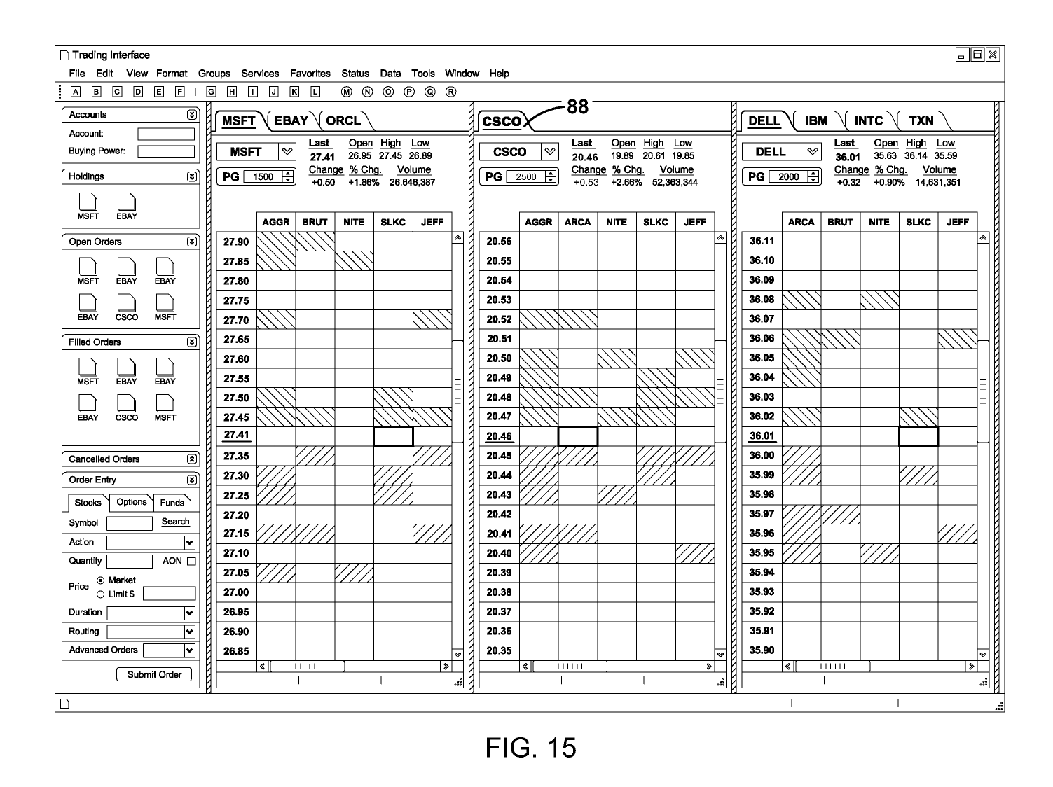

FIG. 15 continue the progression shown in FIG. 11 and FIG. 14. Indicated on FIG. 15 is a new third tabset in the middle of the original two depicted in FIG. 11. The tabset is comprised of a single tab for CSCO 88. Note that the CSCO tab 85 shown in FIG. 11 has been removed and is now represented by the CSCO tab 88. Tabs for securities, for example tabs 85, 88 may be dragged and dropped between tabsets and within each tabset by the user to organize their trading activity. Multiple tabsets may be created and resized by the separator bars between tabsets.

The Replay Feature provides a graphical playback of historical trading activity and market data and on a grid. Such historical data playback requires a source of archived (historical) quote and/or order data from a user's computer or an alternative source. If the historical data is not available on the user's PC it may be downloaded from a online service provider.

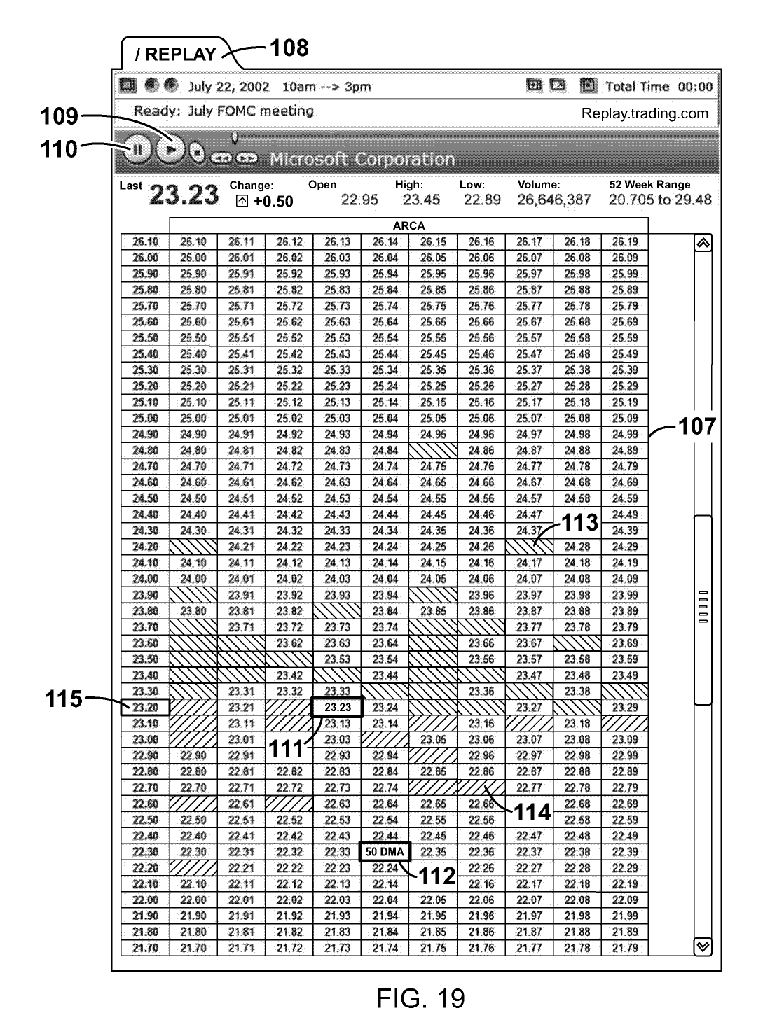

The Replay Feature can record trade and quote data for securities during a trading session and it stores the trade data so that users can “playback” the market activity on a suitable grid viewer such as that of FIG. 19. The user can select which time of the trading session to playback from and how fast the animation proceeds. The trading activity may vary from a real-time speed to a fast speed such as for example, 100 times normal speed. The Replay animation interval can also be fixed a specific time such as, for example, 2 minutes, regardless of the length of the original time interval. The user can choose to store historical data locally through the Replay record function which can store the data on the computer's hard drive.

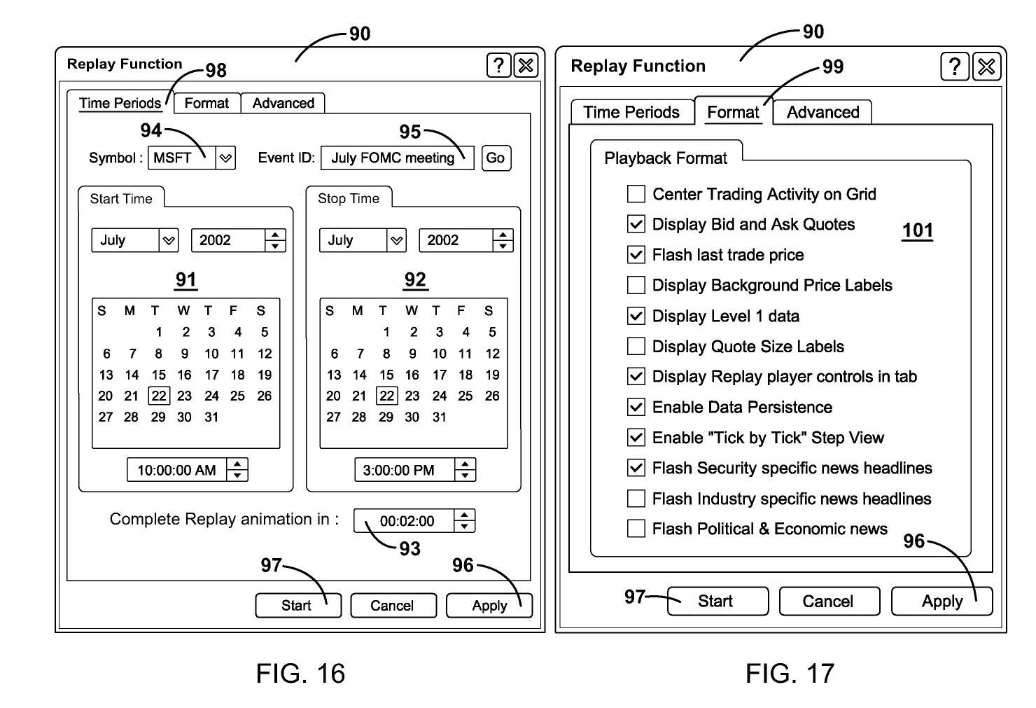

FIGS. 16-18 show the Replay Feature configuration settings panel of the interface 90. FIG. 16 is a representation of the Replay Feature “Time Periods” tab page 98 which permits the user to select historical market data from a predefined time period to Replay based on an event ID 95, or based on a start time and start date 91 and the stop time and stop date 92. The securities symbol is entered or selected from a drop down list so only historical or recorded data specific to the specified security 94 is downloaded and Replayed. The Replay time duration is also specified in hours, minutes, or seconds 93. Settings are effected by pressing the apply button 96 and the data retrieve process begins when the start button 97 is pressed.

FIG. 17 is a representation of the Replay Feature “Format” tab page 99 which permits the user to select the specific market data to be played back such as the data to be shown on the grid (i.e., bid quotes, ask quotes, trades, grid orientation, price labels, and the like). Checkboxes on the Playback Format tab 101 permit such selection.

FIG. 18 is a representation of the Replay Feature “Advanced” tab page 100. This tab page allows the user select filter settings 102 to limit the historical data downloaded from the Data Source provider's site 103 or to limit the amount of data displayed during the Replay animation. Downloaded data may be saved as a file using the Save Data button 106.

The technical indicator button 105 permits the user to selectively calculate and display on the grid a number of technical indicators such as various moving averages. Marker and indicator cells may also be shown on the Replay grid 107.

Text labels associated with each cell's data may be switched on or off by the user. For example, the quote size or last trade size can be displayed for the duration of the animation. When bid and ask quotes appear and disappear on the Replay grid 107, the last trade cell 111 and the bid and ask cells 114, 113 respectively, instantly turn on and off. The data persistence settings button 104 allows the user to lengthen the duration of the graphical “on” and “off” quote and last trade times within a cell to appear and disappear at a slower rate so the data appears to persist within each cell. Similar effects are seen on media players when they playback music.

FIG. 19 is a representation of the Replay Feature playback tab page 108. The Replay Feature records and saves securities trading data for playback and analysis for one or more securities. The Replay playback is typically implemented on grid 107 in real time or accelerated time. The historical trading activity graphically presented on grid 107 may include details of the bid and ask quote prices 114, 113 respectively, and other pertinent data such as the last trade price 111. Technical indicators such as the 50 day moving average price 112 may be seen on the grid 107. A visual indication of the last trade price 111 may also be shown along the price axis 115. The Replay animation may be started by pressing start button 109 and paused by pressing pause button 110. Other buttons such as the stop, rewind, and fast forward buttons are also used to control the playback animation.

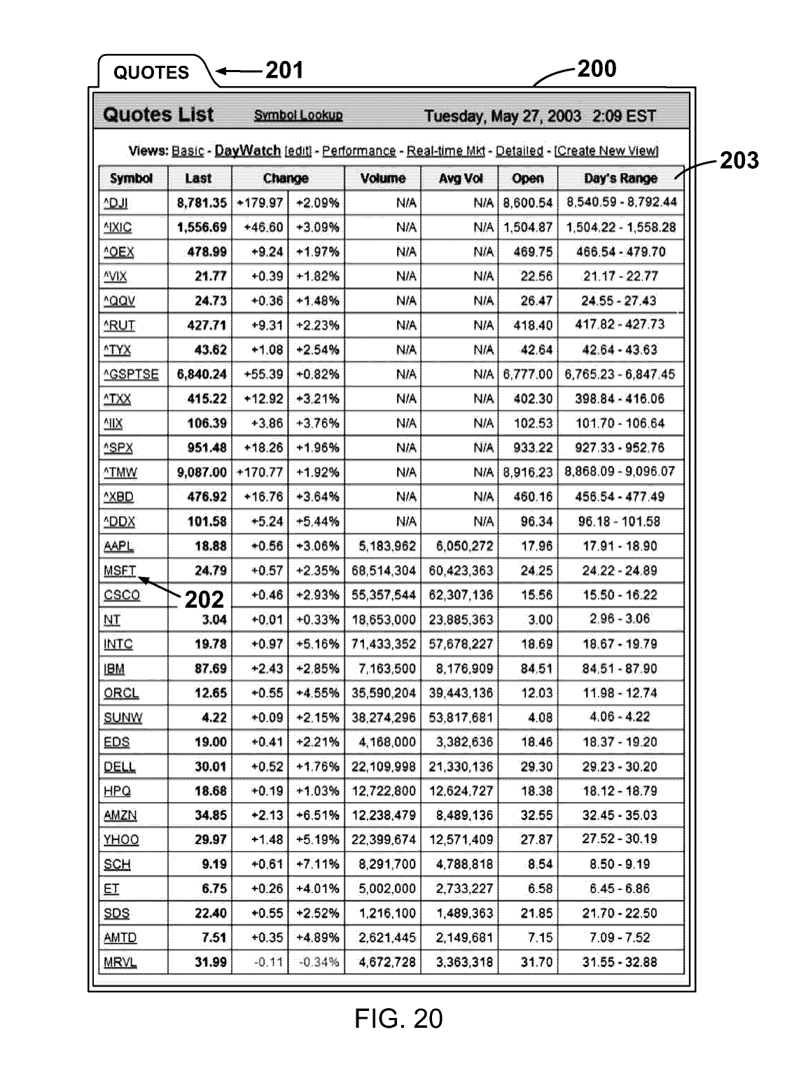

FIG. 20 is a representation of a Level 1 quotes tab page 200. The content of specific tab pages may be identified by an appropriate text label 201. A column header 203 displays the nature of each columns data. Under each security symbol listed, there may be a hyperlink 202 to allow the user to access security specific research or to populate a grid with the associated symbol for convenience.

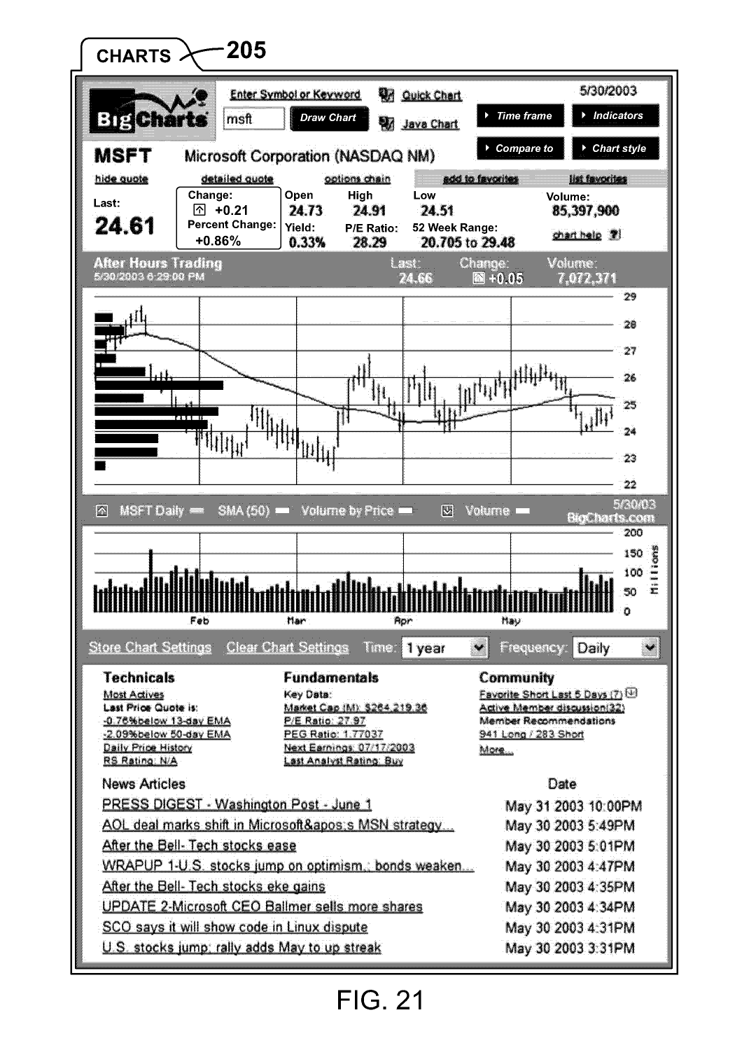

FIG. 21 is a representation of a chart tab page 205 as it may be implemented on the graphical trading interface. Clicking on features or links on the chart may open subsequent tab pages or windows with added content specific to the security or the markets. Content viewed on tab pages may be moved by drag and dropping the tab page within a tabset, between tabsets, or creating a new tabset. The tab page content may also be saved as a file and closed or deleted.

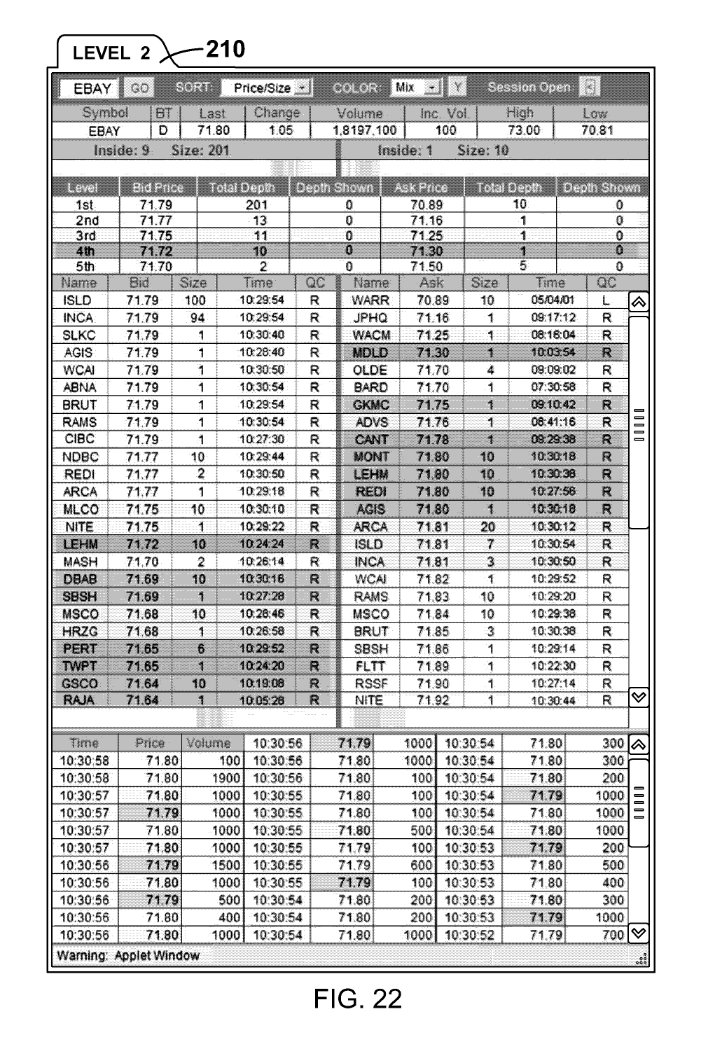

FIG. 22 is a representation of a Nasdaq Level 2 tab page 210 as it may be implemented on the graphical trading interface. Such security specific content allows a trader to gain added insight on the market behaviour of a specific security.

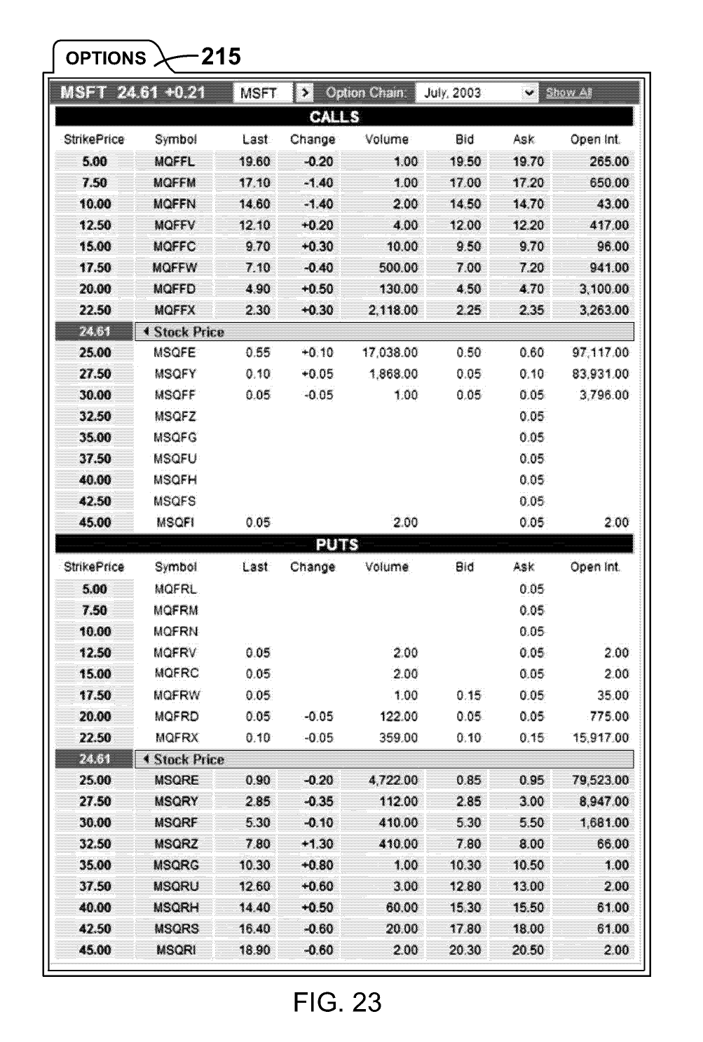

FIG. 23 is a representation of a options tab page 215 as it may be implemented on the graphical trading interface. Options quotes for a specific option may be populated on a grid by double-clicking on the options symbol.

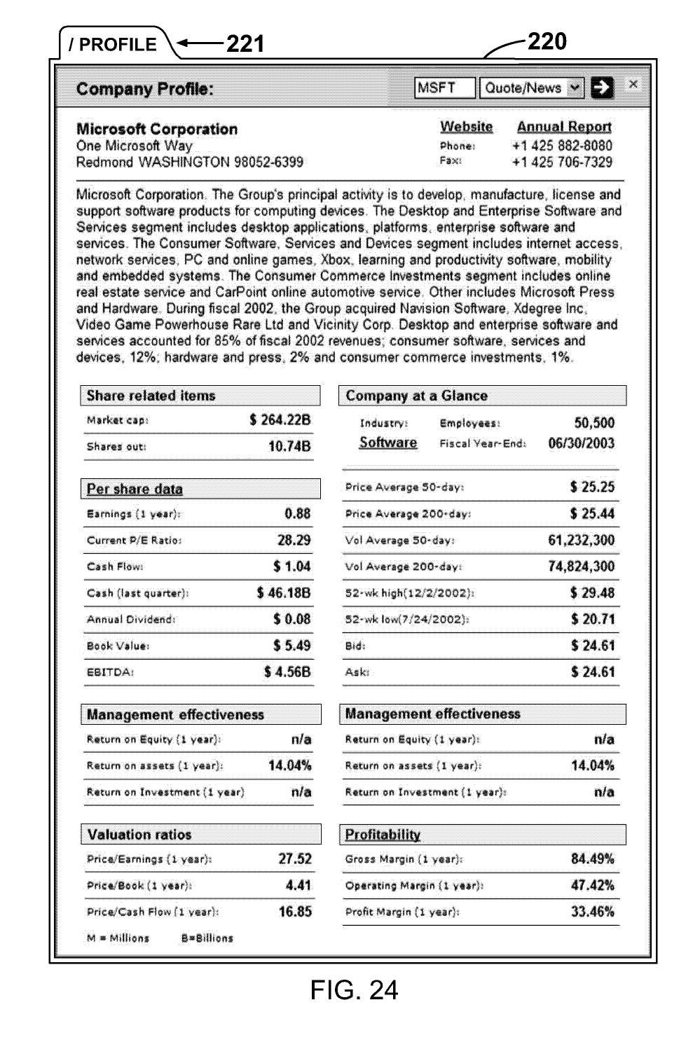

FIG. 24 is a representation of a company profile tab page 220 as it may be implemented on the graphical trading interface. “Pay per use” or subscription content is supported on the trading interface. Such services may be specifically indicated by a prefix or suffix symbol on the tab 221.

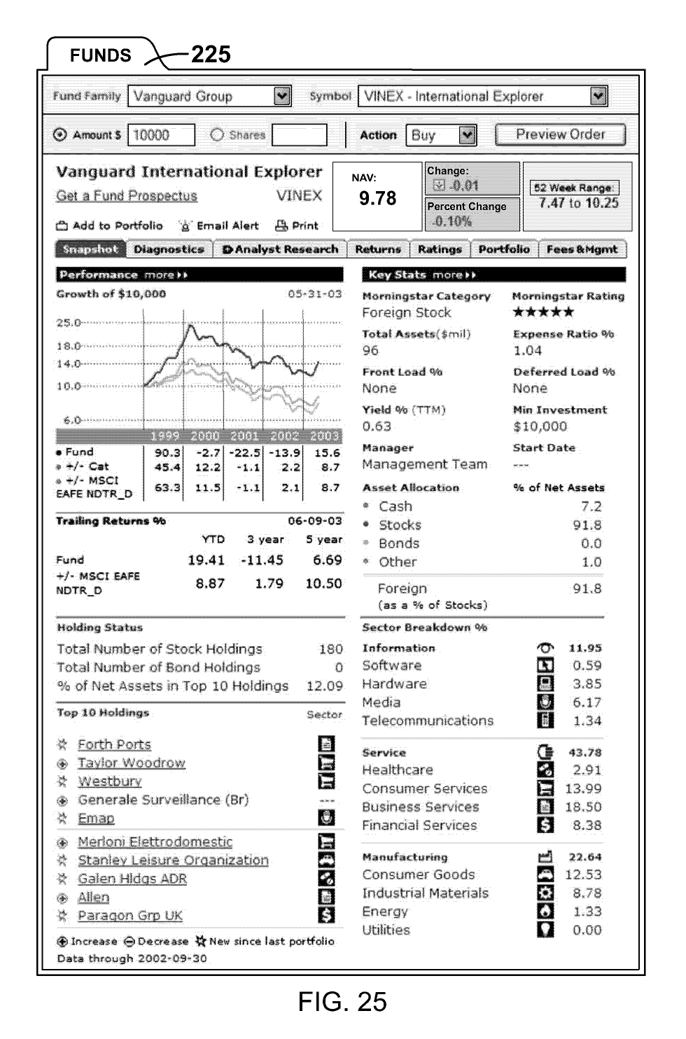

FIG. 25 is a representation of a Fund profile tab page 225 as it may be implemented on the graphical trading interface. Mutual funds and ETFs may be researched prior to purchase by the user. Such research and tab page content may be saved as a separate file for later reference.

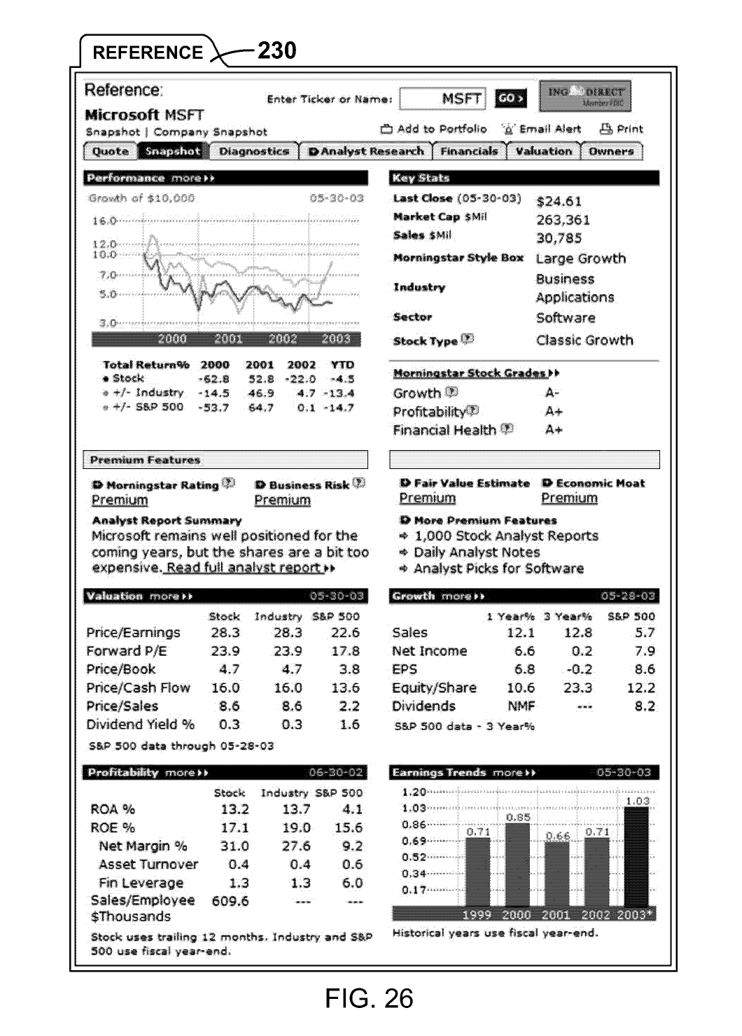

FIG. 26 is a representation of a company Reference tab page 230 as it may be implemented on the graphical trading interface to allow the user to research securities before purchase or sale. Such services may be provided by the online brokerage free of charge, and a nominal charge, or from third party sources of such data by subscription.

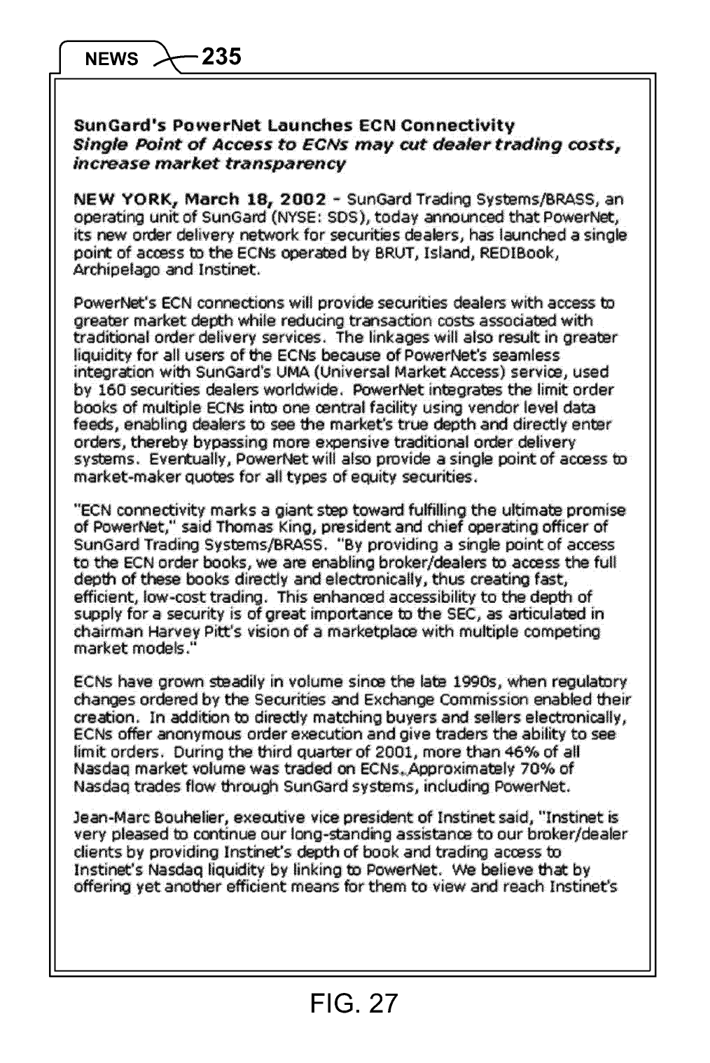

FIG. 27 is a representation of a News tab page 235 as it may be implemented on the graphical trading interface. Such a feature allows the user to be kept up to date on the latest market developments. The News tab page may be configured to filter content for specific securities or industry sectors. The news content may be pushed to the user and automatically populate a tab page.

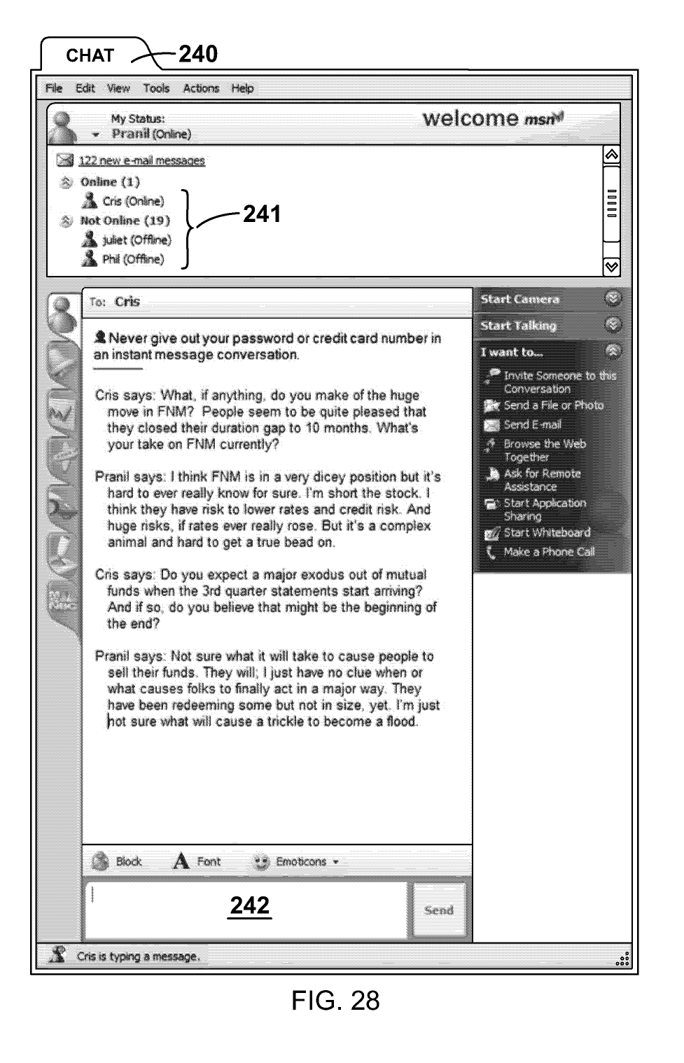

FIG. 28 is a representation of an online chat tab page 240 as it may be implemented on the graphical trading interface. The user may view a list of which of their contacts 241 are presently online. Text messages are typed in the text input area 242. The user may also engage in video “webcam” or audio communications with other users.

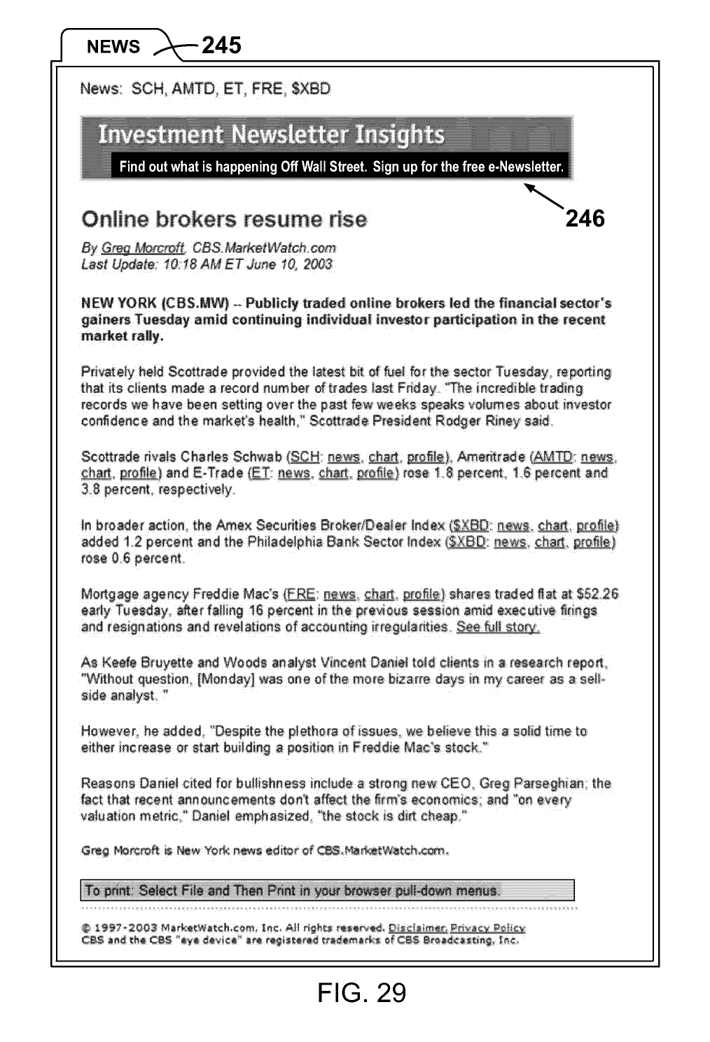

FIG. 29 is a representation of a market analysis tab page 245 as it may be implemented on the graphical trading interface. Such content may be free of charge or subscription based and may electively or automatically populate a tab page when it is received by the user's interface. Advertisement content 246 may be present in such analysis reports.

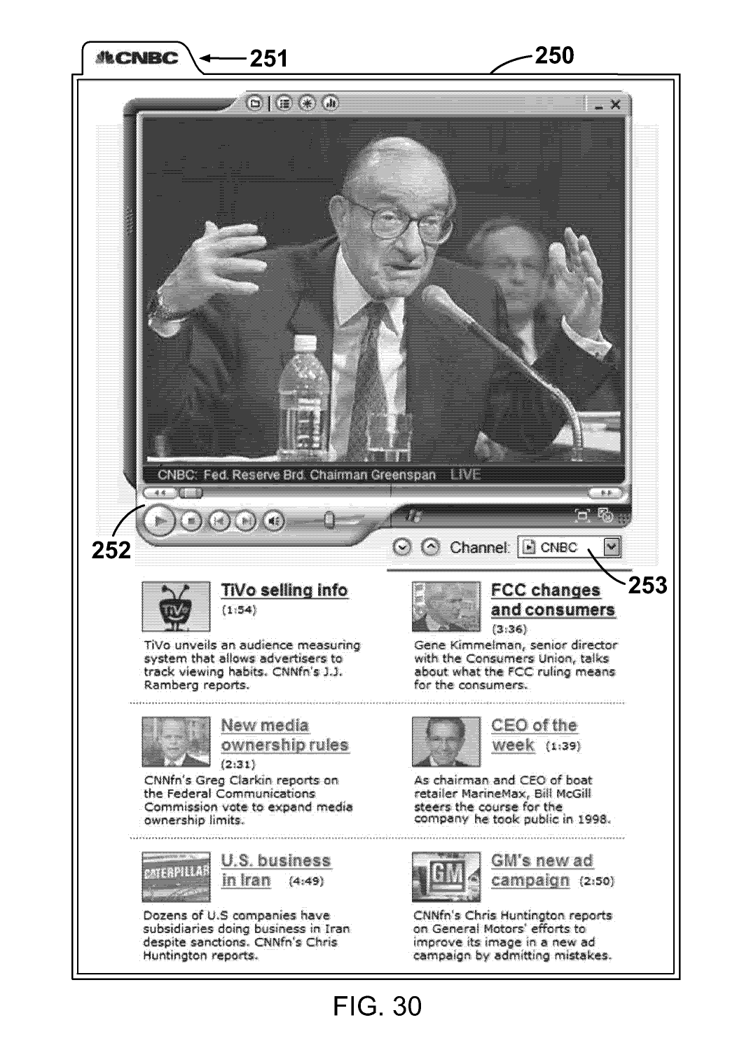

FIG. 30 is a representation of a multimedia player tab page 250 as it may be implemented on the graphical trading interface. Video clips and real time video and audio content may be viewed on the media player 252. Real time market analysis may also be selected on a drop down list 253. Such content may be sponsored by existing sources of market news and such sponsors may display their service mark or corporate logo on the tab 251 for convenient reference by the user.

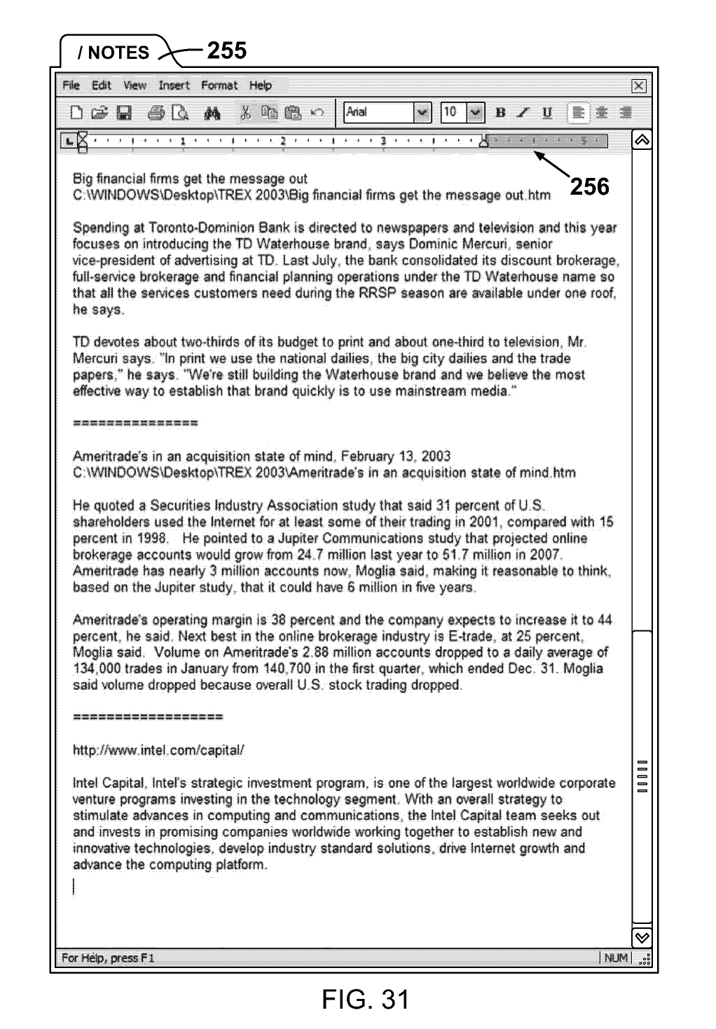

FIG. 31 is a representation of a notepad tab page 255 as it may be implemented on the graphical trading interface. Such a tab page may be used to collect content, write analysis, and clipboard data throughout the trading session. A toolbar and menubar 256 facilitate such functions.

A preferred implementation of a trading interface includes an extensibility framework for easily augmenting or replacing one or more functionalities of the trading interface. Such extensibility framework enables the seamless integration of third party software into the trading interface. The extensibility framework typically includes an Application Programming Interface (API) that allows third party software to be incorporated as “plug-ins” into the trading interface, and container objects that function as visual “containers” for the third party software that are plugged into the trading interface. The trading interface of the present invention uses tab pages as default container objects; however other forms of container objects can also be used such as panels, toolbars, child windows, and the like.

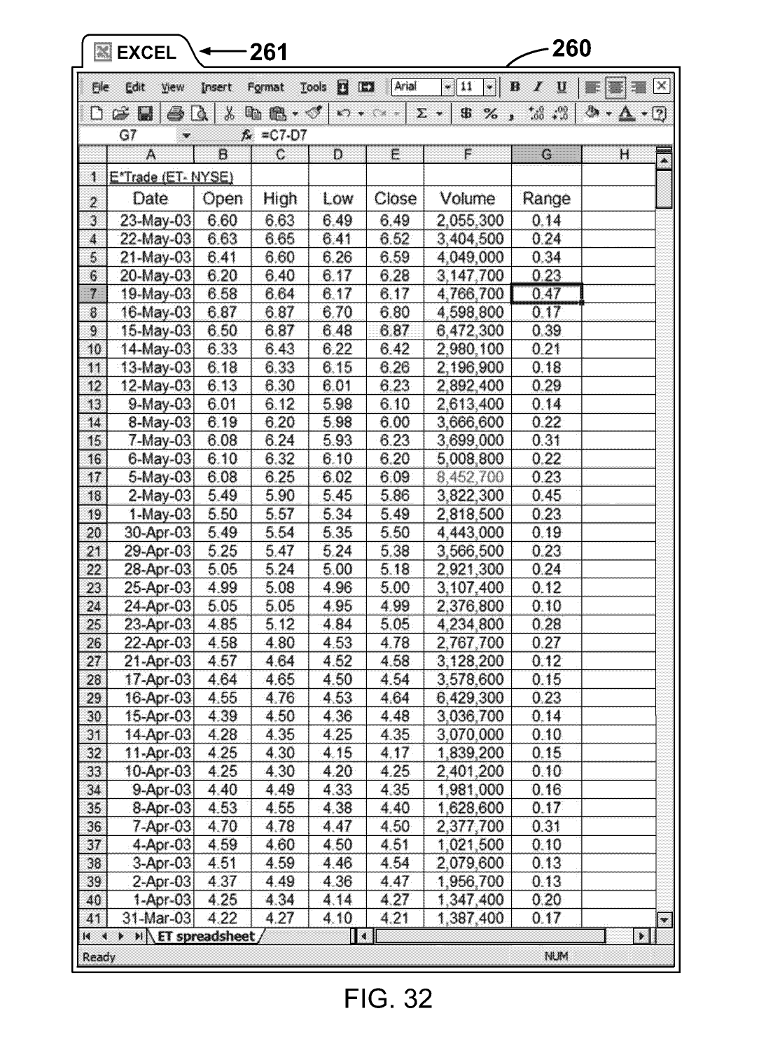

FIG. 32 is a representation of a spreadsheet tab page 260 as it may be implemented on the graphical trading interface. The tab 261 indicates the function of the tab page when the tab page is hidden from view. The Excel worksheet provides a convenient place to analyze, manipulate, and save securities data.

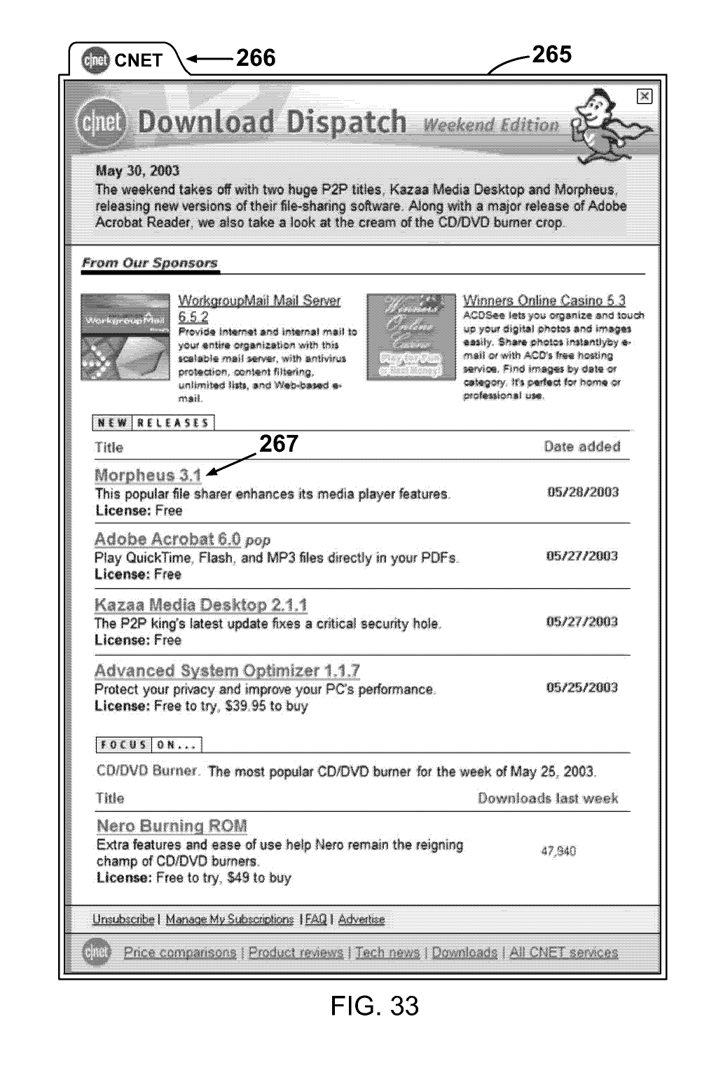

FIG. 33 is a representation of a download tab page 265 as it may be implemented on the graphical trading interface. The sponsor of the content may be indicated on the tab 266. Such download links 267 and software patches may be automatically populated on the interface within a tab page to conveniently keep user's software up-to-date with the latest patches and security features without requiring the user to visit a website from a dedicated browser application.

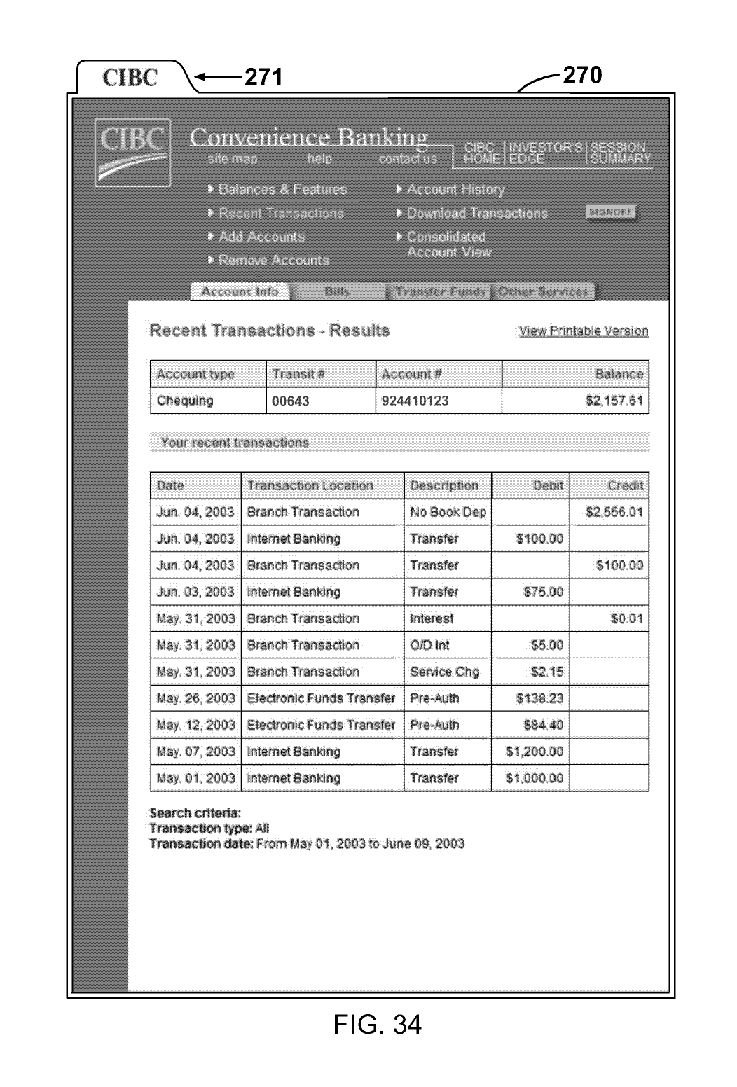

FIG. 34 is a representation of an online banking tab page 270 as it may be implemented on the graphical trading interface. The bank logo 271 is typically present on the tab. Such a service is especially convenient when the user's brokerage is associated with a bank. The integration of both banking and brokerage accounts allows the user to access online banking services or move funds from their banking accounts to their trading accounts from one application.

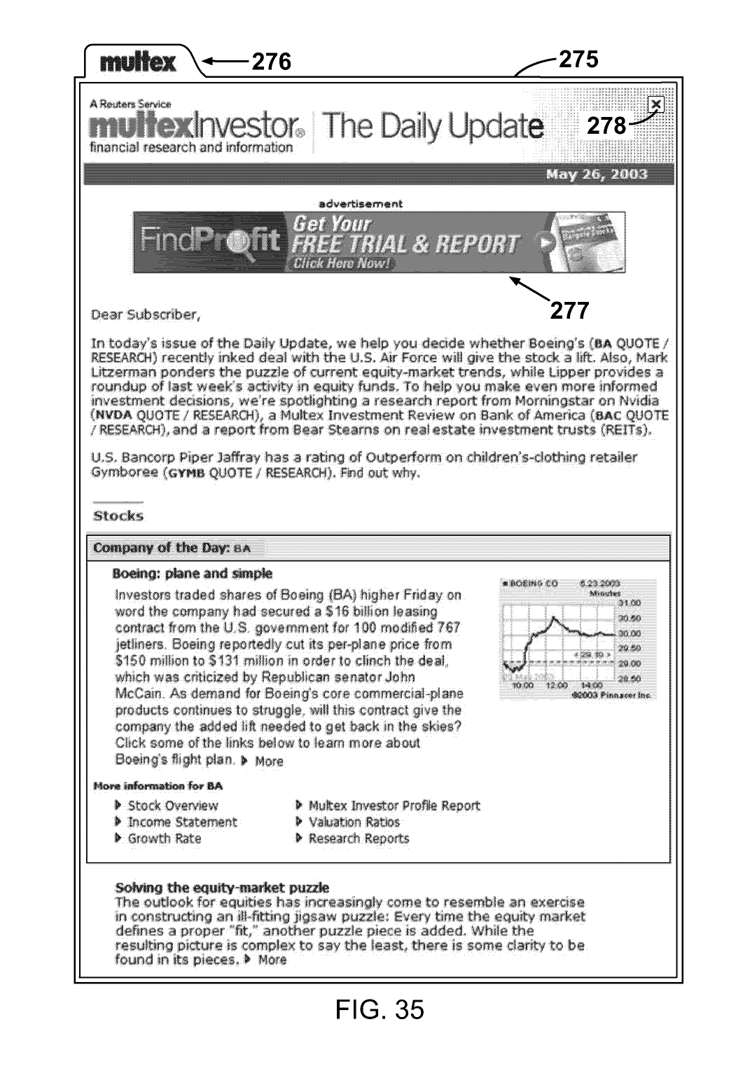

FIG. 35 is a representation of a newsletter tab page 275 as it may be implemented on the graphical trading interface. The newsletter logo 276 or corporate identity may be displayed on the tab 276. Such content may be supported with advertising content 277 and closed using close button 278. The user may register for such services from a website or directly from the interface. It should be understood that targeted subscription content directed to the user may be offered on a trail basis or as a promotion by the brokerage or content provider and that the brokerage may derive revenue for allowing such content to be made available to the user.

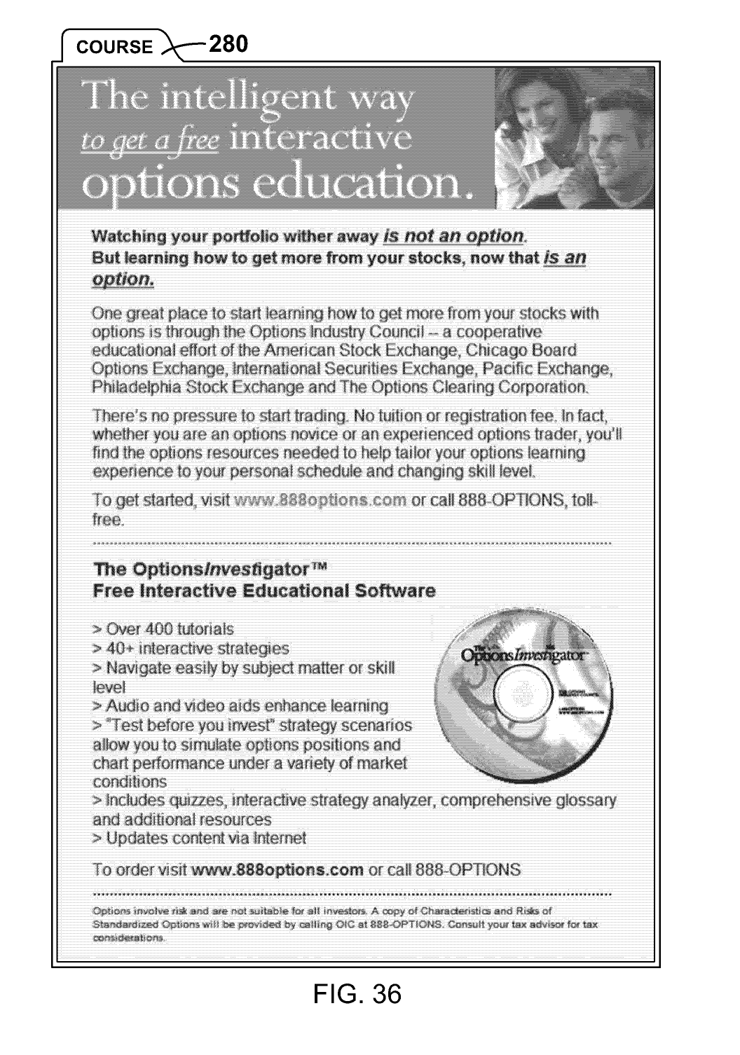

FIG. 36 is a representation of targeted educational advertisement tab page 280 as it may be implemented on the graphical trading interface. If the user chooses to order any services or products from a tab page on the interface, the user may be directed to provide their billing information, visit a website to provide such information, or authorize any fees to be deducted from their brokerage or online banking accounts.

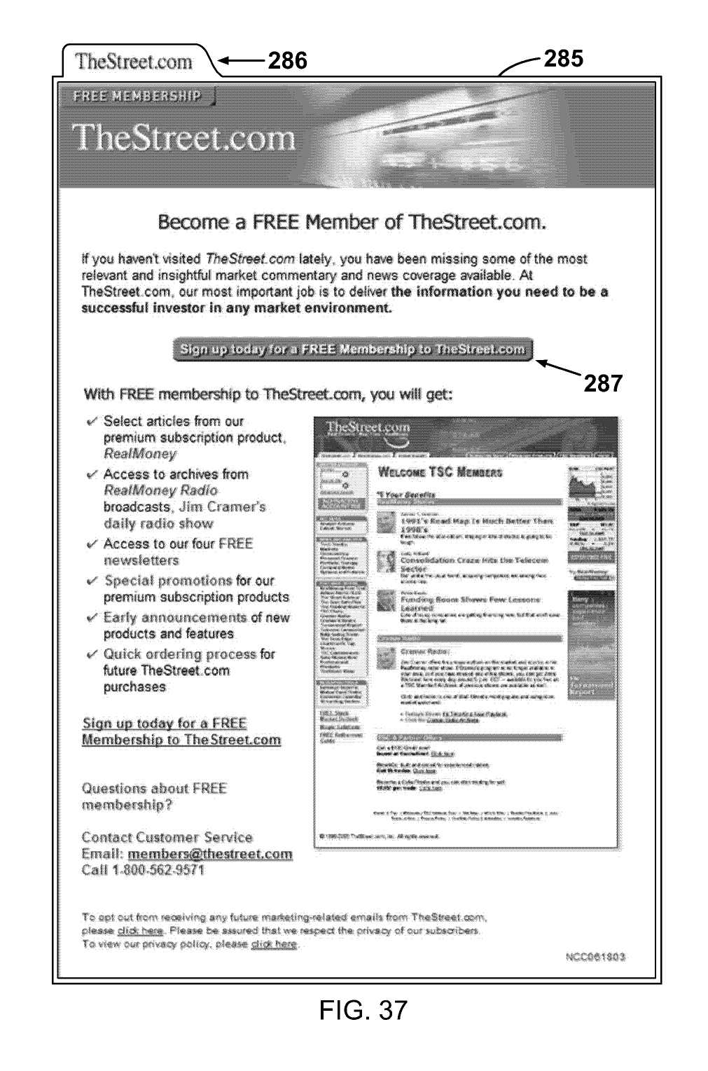

FIG. 37 is a representation of a promotional subscription style advertisement 285 as it may be implemented on the graphical trading interface. The brand logo is visible on the tab 286. A single button 287 allows the user to authorize their brokerage or the software interface to provide the vendor with the necessary user contact and billing details to facilitate the order.

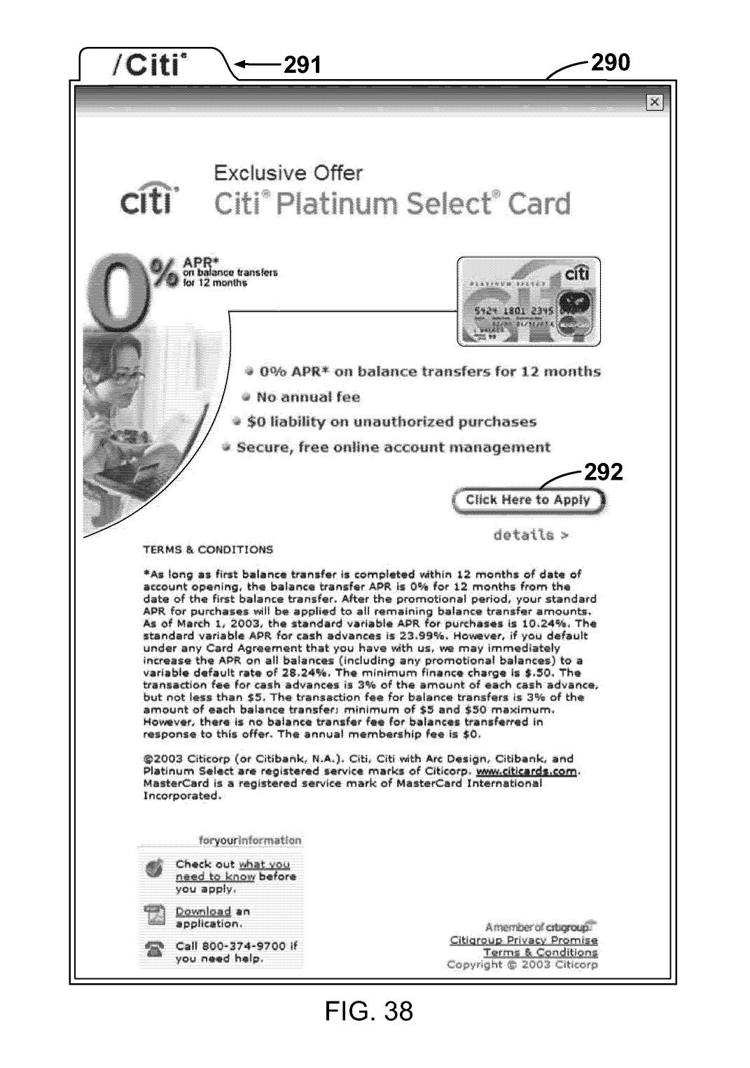

FIG. 38 is a representation of a targeted banking promotion tab page 290 from the online brokerage, their associated bank, or a third party financial institution as it may be implemented on the graphical trading interface. The brand or corporate logo is visible on the tab 291 and a single button 292 may be used to facilitate the user's authorization without requiring the user to fill out a form manually.

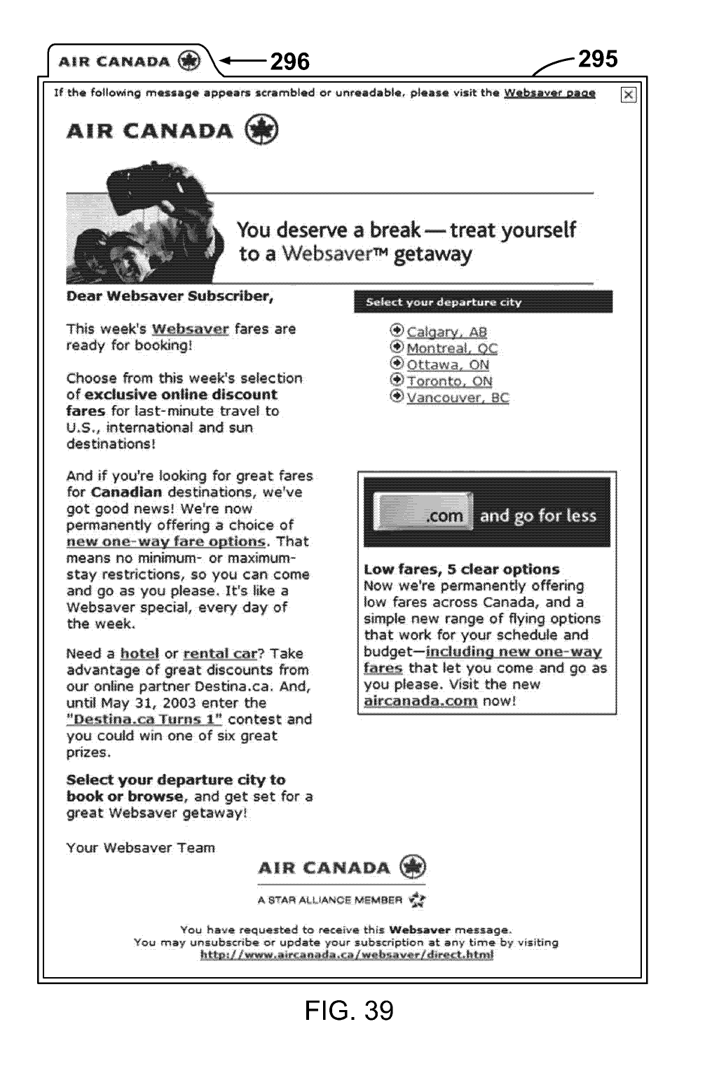

FIG. 39 is a representation of a travel or leisure promotion tab page 295 as it may be implemented on the graphical trading interface. The brand logo is visible on the tab 296. The service or product offered may be determined by the user's account details such as their age, net income, trading performance, portfolio value, cash balance, and the like which in a targeted situation, may be provided by the online brokerage.

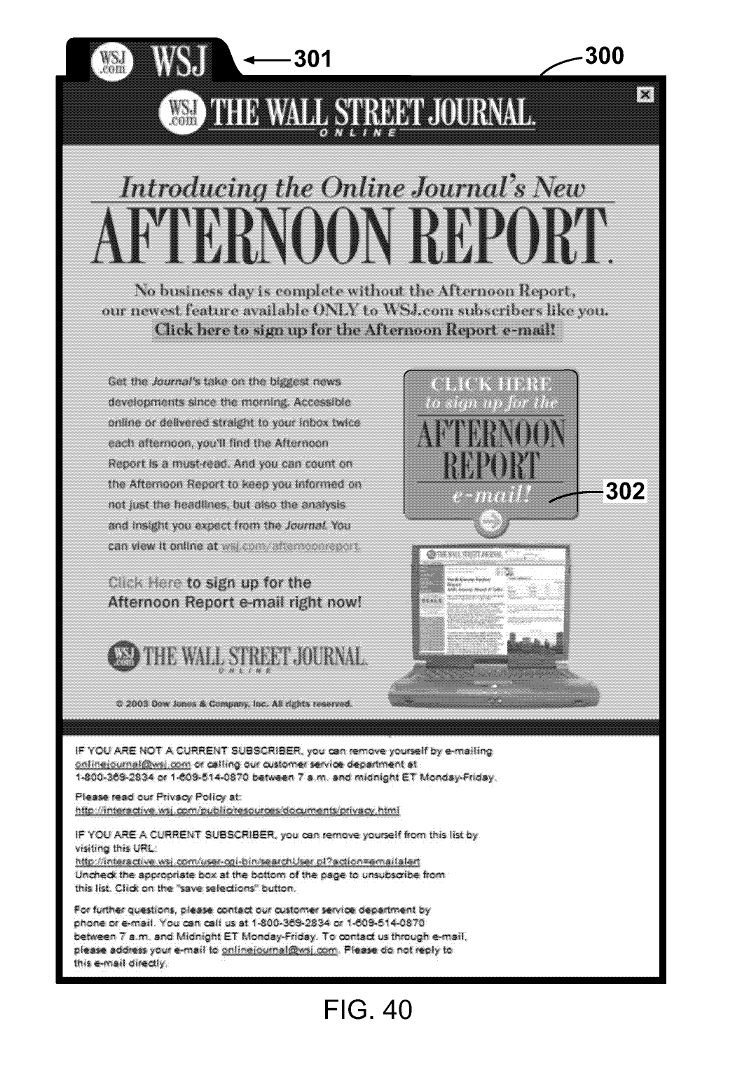

FIG. 40 is a representation of a targeted financial newspaper promotion tab page 300 as it may be implemented on the graphical trading interface. The tab area 301 is visually larger and distinct from standard interface tabs. The brokerage firm derives additional revenue from the larger size and more distinct appearance of the tab 301 which is designed to attract the attention of the user. A customized button 302 on the tab page allows the user to receive promotional content.

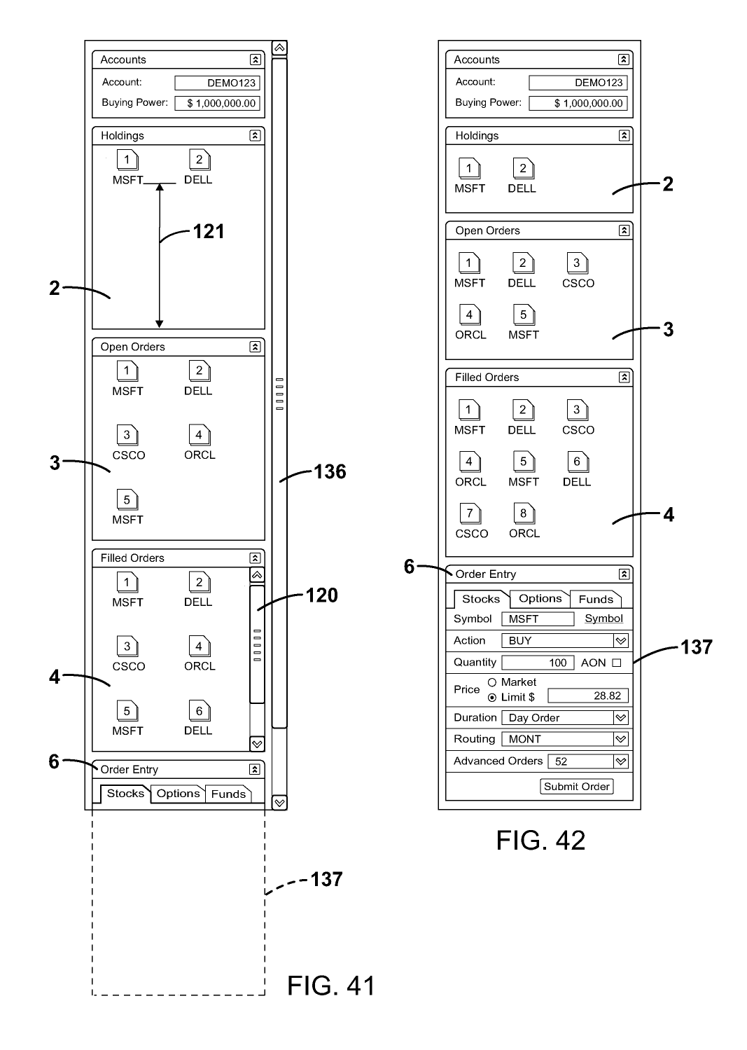

FIGS. 41-46 show how the Icon Packing feature is implemented. In the example of FIG. 41, the Holdings status panel 2 which has only two icons has two empty rows available for icons. In contrast, the Filled Orders status panel 4 has more icons than display area and hence a scroll bar 120 has appeared. As a result, the lower part of the Order Entry panel 6 is obscured from view. The hidden lower part 137 of the Order Entry panel 6 can be scrolled into view via the scroll bar 136. Likewise, the hidden icons in the Filled Orders status panel 4 can be scrolled into view via the scroll bar 120. It may be noted that the presence of the scroll bars 120 and 136 make the screen layout less esthetically pleasing.

The correct icon packing is shown in FIGS. 42, 44, 46 and depicts how the three panels are resized vertically to accommodate the empty rows more evenly and thus improve the appearance and icon distribution within the panels. What we have in the corrected version is a pleasing, well laid out grouping of icons. Hence, there are no scroll bars to distract the user, and that the once hidden lower part 137 of the Order Entry panel 6 is in full view.

Although the total vertical height of the three status panels (Holdings, Open Orders, and Filled Orders) is fixed, the empty spaces in each of the panels can be distributed to lessen the unwanted free space and thus, minimize the chance of the scroll bar from appearing. The less the scroll bar appears, the more pleasing the panels will look. Also, by adjusting the height of each panel, the panels become aesthetically balanced. There is a set number of pixels assigned to each of the panels, such as measuring the number of pixels around the icons in relations to the title bar, the symbol, and the top of the icon.

FIGS. 42, 44, and 46 show how to distribute the free space under the lowest icon of a panel, a feature of correct icon spacing. Each icon corresponds to a specific number of pixels, for example an icon and title is assigned 34×34 pixels. Knowing this, the number of pixels in the free space below the lowest icons (icons are arranged starting from the top in rows), can be determined so that the total number of pixels available in the free space can be assigned an icon.

In a prototype of the trading interface of the present invention, a 4×4 icon per panel spacing is recommended. This means 4 icons can be placed in each row and 4 rows can be placed in the default panel size.

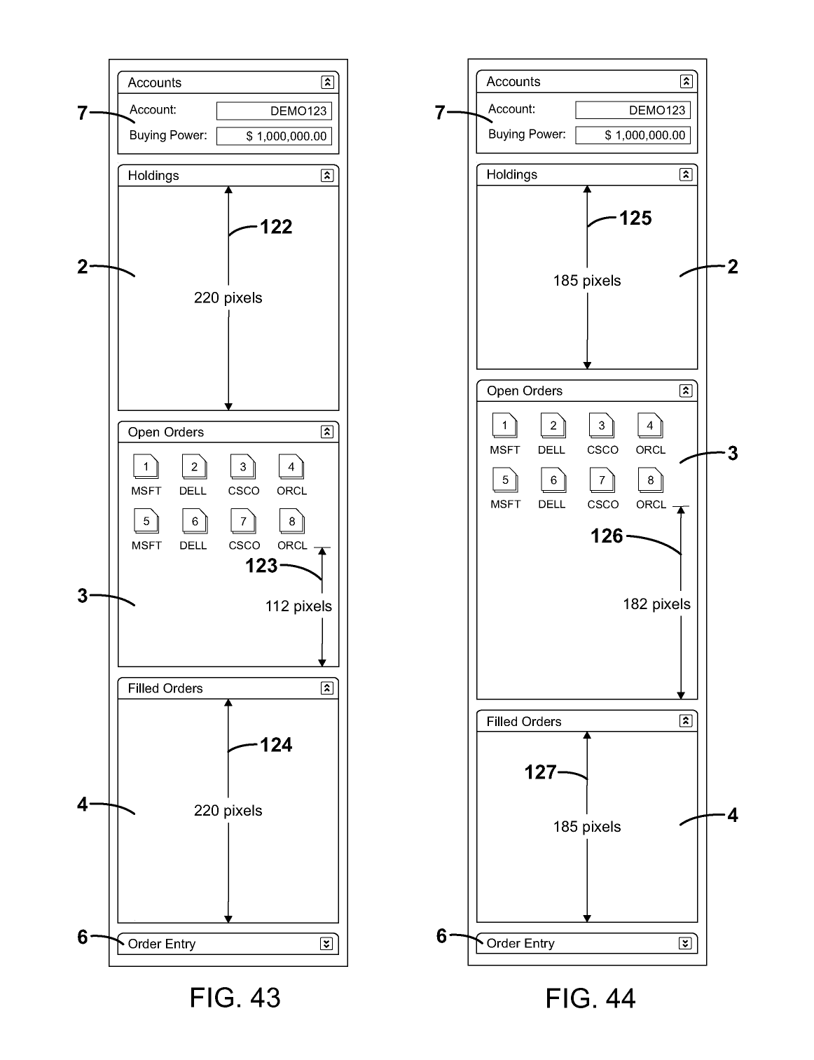

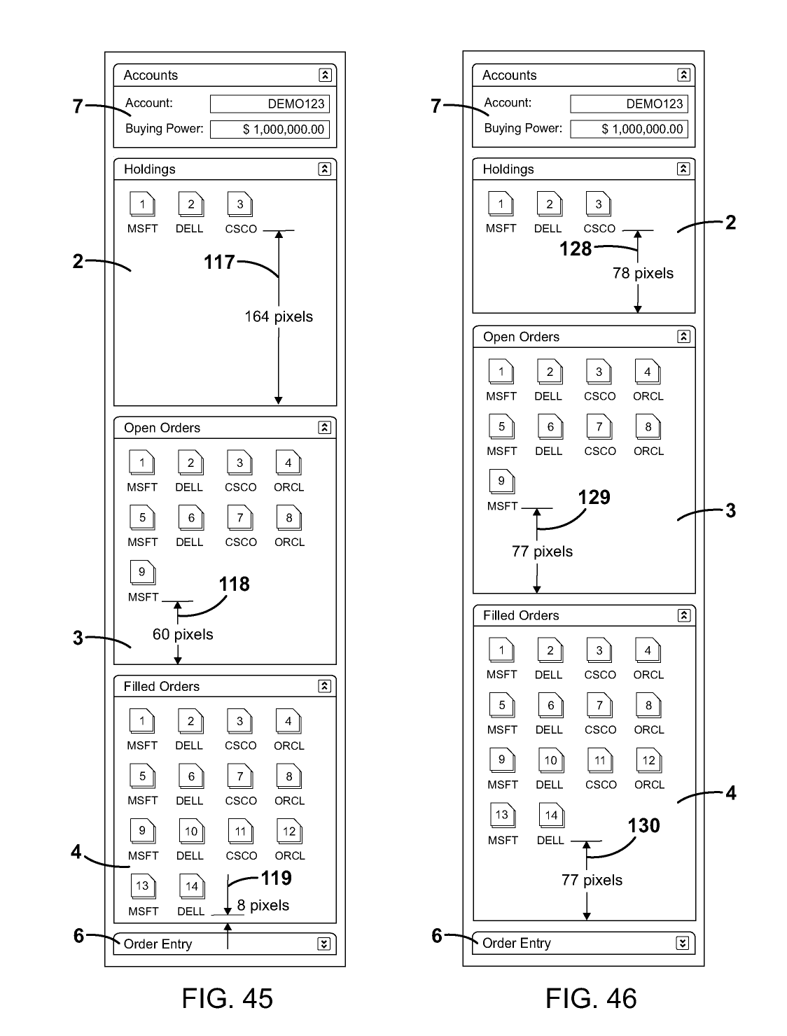

In FIGS. 41, 43, and 45, we see empty spaces with corresponding pixel numbers (representing the height of the free space) in the Holdings and Filled Orders status panels. FIG. 41 shows empty space 121 below a row of icons in the Holdings status panel 2. FIG. 43 shows empty space 122 in the Holdings status panel 2, empty space 123 in the Open Orders status panel 3 and empty space 124 in the Filled Orders status panel 4. FIG. 45 shows empty space 117 in the Holdings status panel 2, empty space 118 in the Open Orders status panel 3 and empty space 119 in the Filled Orders status panel 4.

In FIGS. 42, 44, and 46, the adjusted status panels are shown using icon packing. The number of pixels in the empty spaces has been reduced to make the overall arrangement more pleasing to the eyes and easy to read. FIG. 44 shows reduced empty space 125 in the Holdings status panel 2, increased empty space 126 in the Open Orders status panel 3, and reduced empty space 127 in the Filled Orders status panel 4. FIG. 45 shows reduced empty space 128 in the Holdings status panel 2, increased empty space 129 in the Open Orders status panel 3, and increased empty space 130 in the Filled Orders status panel 4.

The status panels in FIGS. 42, 44, and 46 indicate a reduced chance that a scroll bar will appear given the space constraint of the status area. Correct icon spacing determines how much empty space under the lowest icon can be distributed in a balanced and aesthetic manner so that the appearance of the scroll bar can be minimized or avoided.

Corporate logo icons may be used in the same manner as the interface's default drag & drop icons and status icons. The default Icon may still be used for security symbols where the corporate logos are not available for use on the trading software. The Icons in the open orders, holdings, filled orders, and cancelled orders status panels can be images of the company logos representing the underlying security. The corporate logo icon size may vary according to the dollar value of share size of the open order or holdings. For example, the larger the size of the icon, the more significant the dollar value of the trade. The size of the status icon and the color of the status icon may also vary so that icon size or icon color may be associated with the dollar value profit or loss on a specific trade, the percentage returns associated with a specific trade, or the overall portfolio performance for a given security.

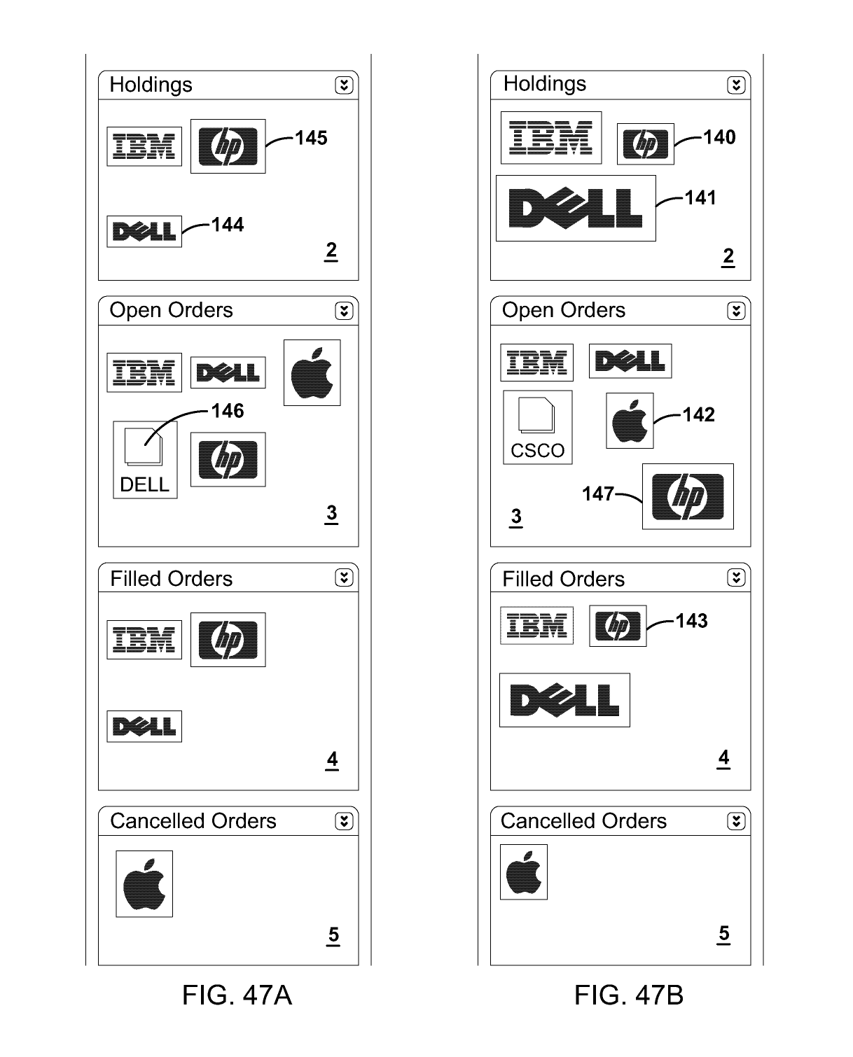

FIGS. 47A and 47B show corporate logos used as status icons within the status panel area of the interface. Corporate logos or other related symbols associated with the underlying security may be displayed, as shown in the Holdings 2, Open Orders 3, Filled Orders 4, Cancelled Orders 5 status panels of FIG. 47A. Logos of a standard size are shown for HP 145 and DELL 144. If Corporate logos are used, a text label for the symbol below the icon may not be necessary and may be disabled. If a Corporate logo is not available or permission is not given to use it, a default icon 146 is used in its place.

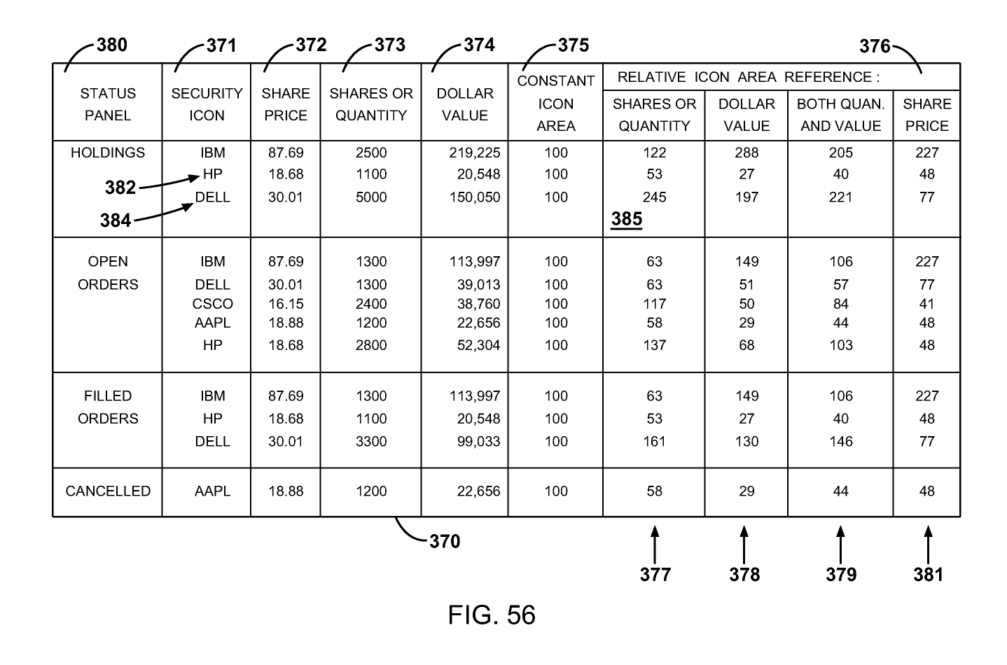

FIG. 47B also shows corporate logo icons in the status area. However, the size of the icons vary according to the size or dollar value of the holdings or orders. Thus the HP 140 and DELL 141 holdings are shown to be different in terms of quantity, dollar value, or some related parameter. Similarly, the AAPL open order 142 is shown to be smaller than the HP 147 open order (the user, the interface, or the brokerage configure which parameter of a security determines the icon size differences; See table 370 of FIG. 56). Filled orders such as HP 143 and cancelled orders may also be related visually in terms of their relative size.

Corporate logo Icons may also be dragged and dropped on the grid and displayed on the grid as an order icon. The Logo Icons function with the order locate and icon locate features similar to regular (default) icon shapes.

Status Icons associated with Status panels 3, 4, 5, and the like, may appear to be “stamped” with text images which emulate a “hand stamp”. The stencilled representations of words such as “FILLED”, helps users to gauge the status of their various open and filled orders. The order type (for example, buy, sell, or short) may also appear stamped on a default icon image. Cancel orders may also be indicated as such.

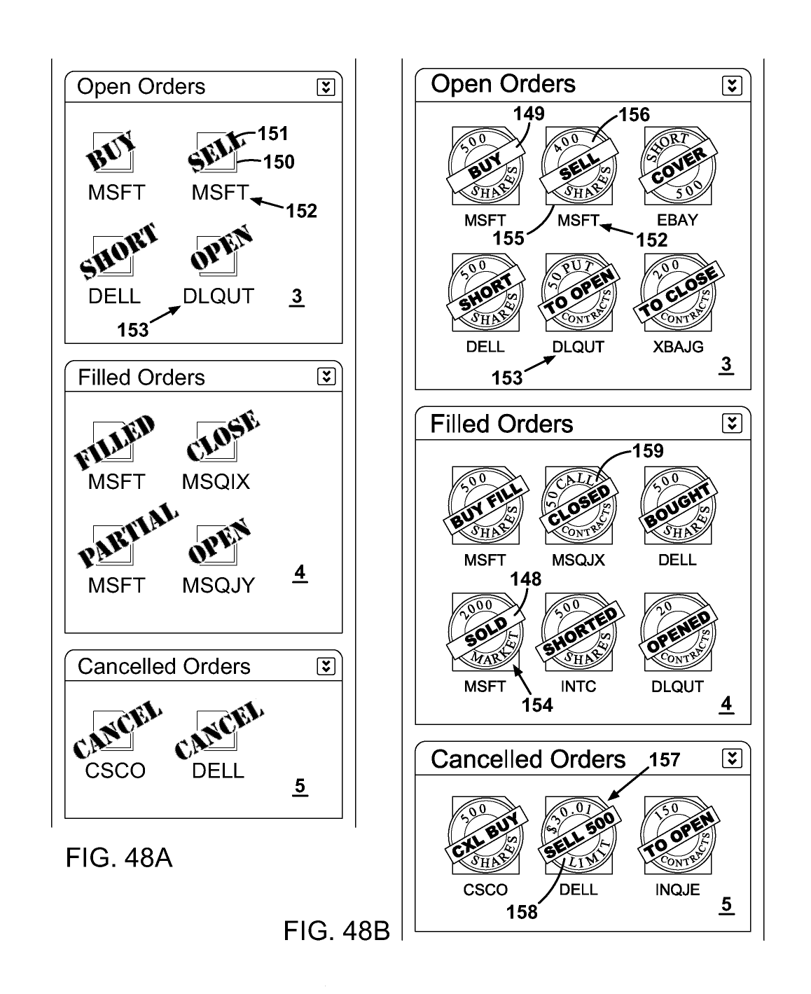

FIGS. 48A and 48B show status icons which are stamped as to their order type (buy, sell, short, and the like), or status (filled, cancel, partial, and the like). Shown in FIG. 48A is a default icon body 150 with a “SELL” stamp image 151 associated with a security symbol 152. For an Option order Icon 153, “OPEN” and “CLOSE” or “opened” and “closed” text labels may be used to indicate order status.

Shown in FIG. 48B is a default status icon image 155 with a more comprehensive stamp image 156 applied to it. The icon and its stamped image is associated with a security symbol 152. A variety of example “stamped icon” presentations are shown in FIG. 48B, including stamps which reference to an order type 149, an order status 148, an order designation (a “MARKET” order 154; a “LIMIT” order 158), a limit price 157, an options order 153, or an option series type and quantity (“50 CALL” contracts 159).

A crossed market occurs when the bid price is higher than the ask price. Often, a crossed market occurs when multiple market bid ask quotes are aggregated into a common display. A locked market occurs when the bid price is equal to the ask price.

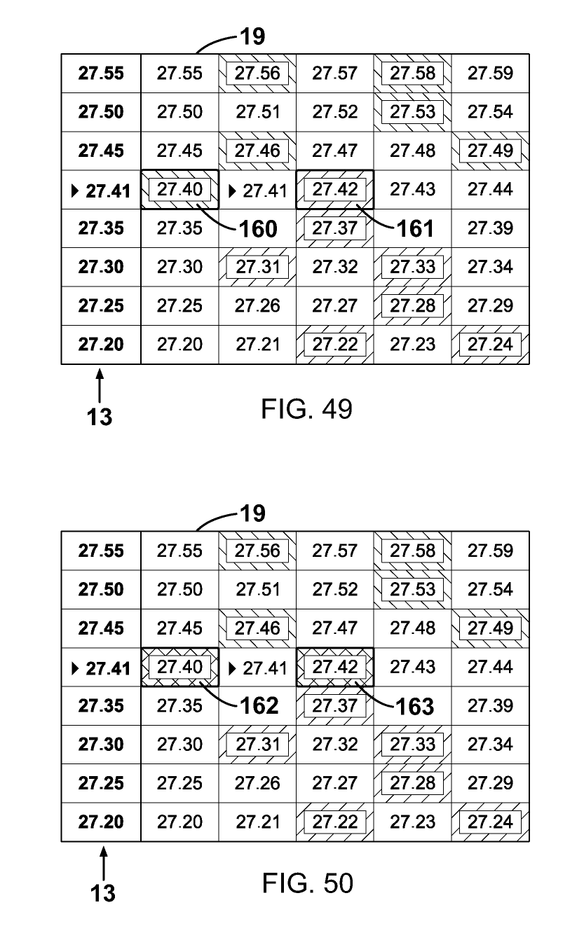

FIG. 49 shows a crossed market situation on the Grid 19. The bid cell 161 at a price of 27.42 is higher than the ask cell 160 at a price of 27.40 (the price is indicated by a text label on the bid cell and on the ask cell). There is also a last trade graphical indication (an arrowhead) at price 27.41. The user has configured their price axis 13 to show the last trade price as a text label within the price axis cell closest to the last trade price. A last trade graphical indication (an arrowhead) is also shown on the price axis cell.

In a crossed market situation, having a bid cell (a bid cell typically presented as a distinct color such as blue) above an ask cell (an ask cell is typically presented as a distinct color such as red) may be confusing for some users as it may appear as if the software program is malfunctioning. The trading interface allows the user to configure the interface to show the cells affected by the crossed or locked market in a visually distinct color. For example while bid cells are typically colored blue and ask cells are typically colored red, the crossed market cells (where the read and blue cells overlap) may be colored in a visually distinct color, for example, yellow.

FIG. 50 shows the crossed bid cell 161 and ask cell 160 of FIG. 49 with a crossed market indication. The bid cell appears in a distinctive color, for example yellow, indicated at 163, and the ask cell appears in a similar distinctive color indicated at 162 in FIG. 50. Thus the user sees the distinct color associated with a crossed market and there is less confusion associated with the crossed market event when it is presented visually on a grid 19.

In the case of a locked market, in which both the bid cell and ask cell are at the same price (or when the bid price and ask price are both represented within the price range associated with a single cell), the same visually distinct cell color may be applied (for example a yellow color) to the cell. It should be understood that any visual distinction such as font size, font style, text labels, and additional graphical elements may be used to indicate a crossed market, a linked market, and bid and ask prices within a common cell.

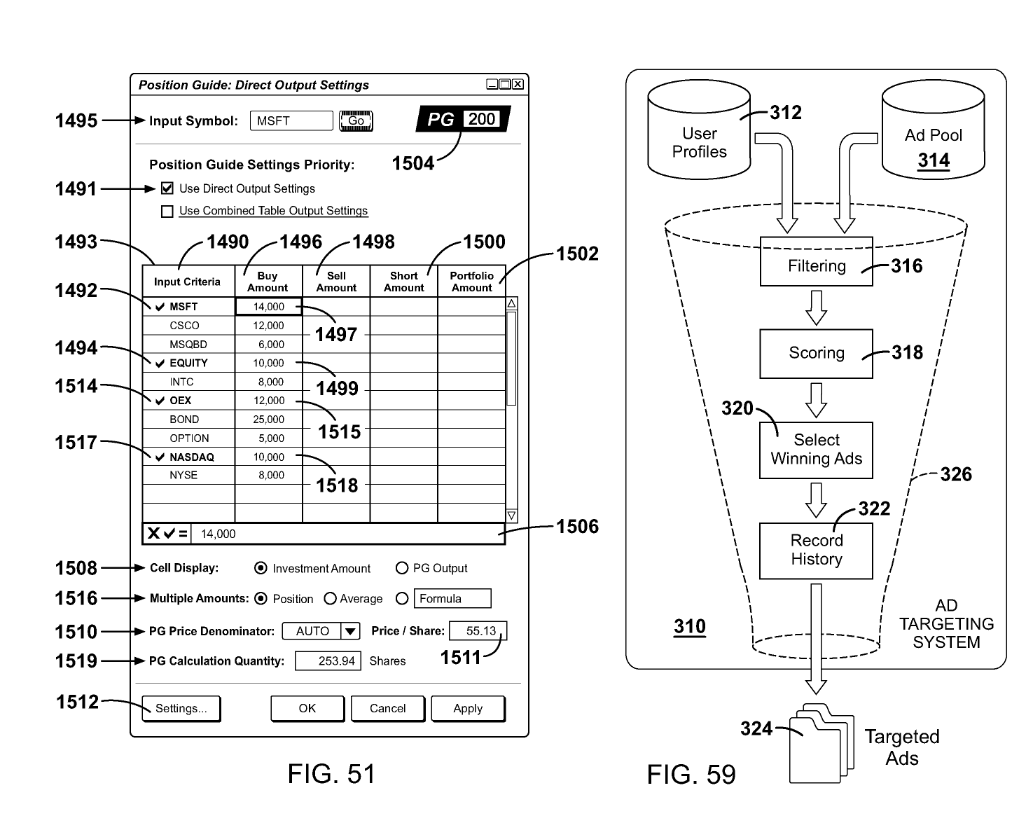

FIG. 51 is representative of the Position Guide Direct Output Settings panel. The Direct Output Settings panel provides a intuitive configuration method for allocating an investment amount for a given PG input security based on the security's symbol, sector, asset class, index association, listing exchange, and the like. In settings area 1493, the first column, the input criteria column 1490, indicates the input criteria or input category type for which each investment amount 1497 in each row 1492 is designated. For each input criteria or input category type, one or more columns are shown for entering the designated investment amount allocation by order type. For example, shown are columns for designating a buy order amount 1496, a sell order amount 1498, and a short order amount 1500. It should be understood that new columns may be created for additional order types, and that a single column may contain the designated investment amount data for more than one order type. For example, a single column may be configured to enter a designated investment amount for both sell and short order investment amounts.

It should be understood that each of the buy, sell, and short order columns may be separated and presented visually within its own tab page. Similarly, the tab sets may be arranged according to the asset class of the PG input security. The segmented tab set may be presented to further segregate PG input security symbols and their designated investment amounts by their respective asset class.

There is also a column for designating a portfolio amount limit 1502 for each input criteria or input category row or cell. A Portfolio Amount is the total value of a PG input security or input category type the user may maintain or hold in his overall portfolio. The portfolio amount or portfolio investment amount, limits the value or proportion of a given security in the user's overall portfolio. A Settings button 1512 is shown to indicate access to more advanced configuration options for the Settings panel.

Each input cell within the settings area 1493, may be edited by selecting the cell and entering or modifying the data inside the cell. Data and values for a selected cell may also be entered or edited through input box 1506. For example, if “Microsoft Corporation” or “MSFT” 1492, is input to the Position Guide, the PG will recommend a buy share quantity equivalent to $14,000, the designated investment amount 1497 input by the user or a third party for a buy order. This buy investment amount is indicated in selected cell 1497 and input box 1506. Similarly, the user may specify a sell order amount and a short order amount for “MSFT” in each order type's column 1498, 1500 respectively.

The PG icon 1504 displays the PG Output quantity for a given PG input security. The given PG input security may be selected from the settings area 1493, the PG Input Symbol area 1495, or the grid proper tab page. Formulas, variables, template names, table names or table symbols, and scripting language commands may be entered in select input cells to further facilitate a suitable PG Output quantity recommendation.

When formulas, variables, template names, table names or table symbols, and scripting language commands are entered in input criteria column 1490, the resulting output amounts of the formulas, variables, template names, table names or table symbols, and scripting language commands, for a given PG input security, may be displayed in any investment amount column such as buy order column 1496. The PG input security 1495 is available as input into the formulas, variables, template names, table names or table symbols, and scripting language commands. If the formulas, variables, template names, table names or table symbols, and scripting language commands are not configured or intended for a specific order type, asset class, or a given PG input security, the output value of the formulas, variables, template names, table names or table symbols, and scripting language commands will not be computed or displayed in their respective buy, sell, or short investment amount columns 1496, 1498, 1500.

Formulas, variables, template names, table names or table symbols, and scripting language commands may be entered in an investment amount column, such as buy amount column 1496, as well as the Input Criteria's column 1490. This approach also limits the calculated formulas, variables, template names, table names or table symbols, and scripting language commands output amounts to the specific cell of the investment amount column where the formulas, variables, template names, table names or table symbols, and scripting language commands have been entered.

In this situation, only PG input symbols which match the security symbol or the Input Criteria 1490 are subsequently input into the formulas, variables, template names, table names or table symbols, and scripting language commands to derive an output value. This approach effectively filters the PG input symbol 1495 through the input criteria column 1490 so that the PG input security 1495 is only input into the formulas, variables, template names, table names or table symbols, and scripting language commands, if the Input Criteria cell in column 1490 has already accepted or validated the input security for a given input criteria.

If an Index symbol is entered in a cell of the input criteria column 1490, it should be understood that the Index symbol is merely a convenient method of indicating that the associated investment amount for a given order type is intended for each of the index's component stocks. For example, the OEX index symbol 1514 shown in the Input Criteria column 1490, indicates that each PG input security which also happens to be a component of the OEX index will be allocated or designated an investment amount of $12,000, as shown in adjacent cell 1515, if the intended order is a buy order.

The units and formatting of each column and cell may be adjusted with a right-click operation on the column header or cell. For example, a sell amount may be specified in share units rather than a dollar denominated value.

Occasionally, for a range of input criteria indicated under the Input Criteria column 1490, the Position Guide may detect more than one qualified input criteria for a given PG input security. In FIG. 51, for example, the PG input security is “MSFT” and this results in four input criteria matches, each with their respective investment amounts for a buy order indicated in column 1496. The first qualified or satisfied input criteria corresponds to the “MSFT” symbol 1492 as this is the PG input security symbol; the second satisfied criteria corresponds to the “EQUITY” category 1494, as MSFT is an equity security; the third satisfied criteria corresponds to the index symbol “OEX” 1514, as MSFT is a component stock of the OEX index; and the fourth satisfied criteria corresponds to the “NASDAQ” symbol 1517, as MSFT is also a Nasdaq listed security. The four corresponding PG buy order investment amounts for these four satisfied input criteria are: $14,000 for the “MSFT” PG input symbol 1497, $10,000 for the “EQUITY” input category 1499, $12,000 for the “OEX” input category 1515, and $10,000 for the “NASDAQ” input category 1518.

The Multiple Investment Amounts section 1516 permits the user to select the method used when, for a given PG input symbol 1495, more than one valid input criteria or input category type 1490, results in more than one valid corresponding investment amounts for a given order type. Generally, the investment amount associated with the highest satisfied criteria or highest row position that matches an input criteria 1490 for a given PG input security 1495 is chosen as the final investment amount. In FIG. 51, this position rank method of handling multiple valid input criteria is selected 1516. For example, since the “MSFT” input criteria 1492 has the highest position rank of the four satisfied input criteria in the input criteria column 1490, the final investment amount is $14,000. The Position rank approach to multiple satisfied input criteria permits the user to position the higher priority security symbols and input criteria near the top of the input criteria list 1490.

Alternatively, when there are multiple satisfied input criteria for a given input security, the final investment amount may be the minimum, maximum, median, mode, or average of their various associated investment amounts. Similarly, an alternative ranking method may provide that a PG input security's symbol in the input criteria column 1490 has the highest priority, followed by an index symbol if the PG input security is a component, followed by the sector type to which the PG input security belongs, followed by the asset class of the PG input security, and the like.

The Position Guide Settings Priority area 1491 permits the user to select which PG Output Settings panel takes priority when the PG detects a conflicting configuration between two or more settings panels. The user may access the Settings panel from a html link to edit the conflicting settings information.

The relevant PG input security price 1511 that is used to calculate the PG Calculation quantity may be selected from the drop down list associated with the PG Price denominator 1510. The PG Price Denominator may be the limit price of the intended order, the last traded price, or the high, low, bid, ask, or opening price for the security. An “AUTO” setting in the drop down list permits the relevant security price 1511 to be adjusted automatically for each order type. For example, in the “AUTO” setting, an intended buy order may use the ask price of the PG input security before the order is placed on the Grid Proper. Once the intended Order is dragged onto the Grid Proper, the corresponding limit price is used as the relevant security price. The final investment amount as derived from the settings area 1493 is divided by the relevant security price 1511 to determine the PG Calculation quantity 1519. For example, the derived investment amount for “MSFT”, as discussed previously is $14,000, and this amount 1497 is divided by $55.13, the relevant security price for “MSFT”, to calculate the PG Calculation value of 253.94 shares. The decimal PG Calculation quantity undergoes output conditioning and the final value is subsequently displayed in the PG icon 1504 as the PG Output quantity.

For convenience, the PG Output quantity corresponding to each cell's investment amount may be displayed inside their respective investment amount cells, for example 1497. The Cell Display radio buttons are provided for this purpose 1508. To view the PG Output quantity, in share units, inside each suitable cell, the “PG Output” radio button is selected.

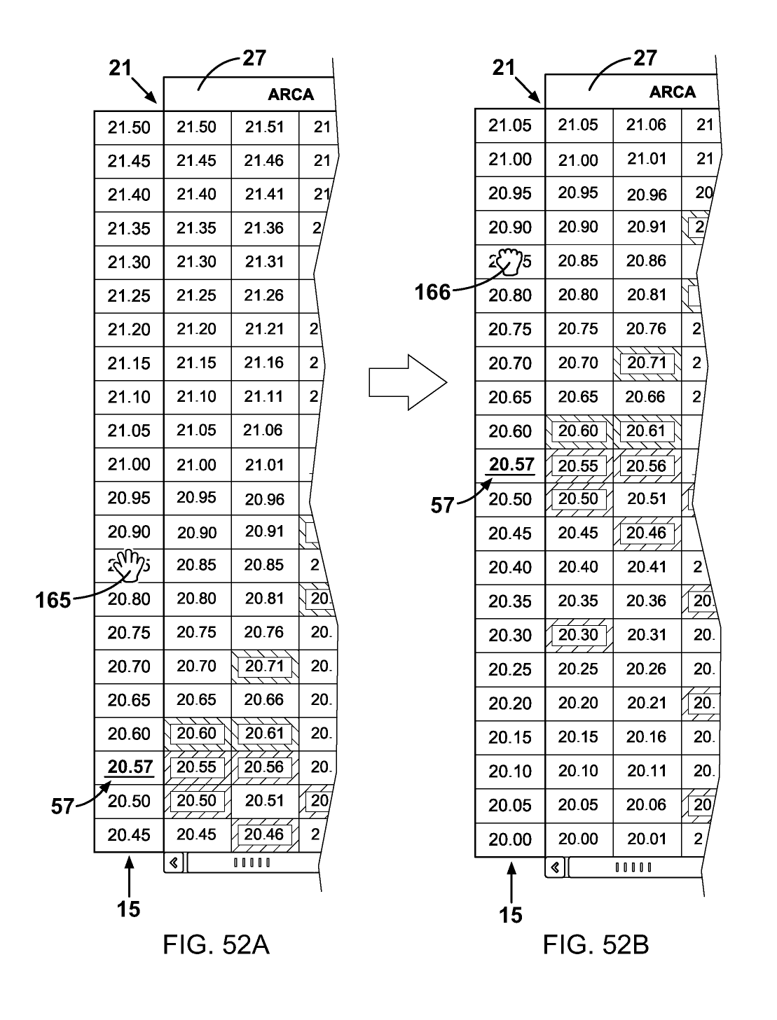

FIGS. 52A and 52B illustrate the hand-grab feature used to move the grid 21 and its associated price axis 15 up or down as desired by the user to view trading activity on a different portion or price range of the grid or to manually align the trading activity on the grid 21. In FIG. 52A, the open handgrab icon 165 is positioned in the lower part of the grid price axis 15. The grid price axis 15 is subsequently grabbed and moved higher up the grid as indicated by closed handgrab icon 166. The user may repeat the handgrab action as desired. Note that the last trade price indication 57 on the price axis has moved higher from FIG. 52A to FIG. 52B.

When the grid 21 is moved up and down or left and right, the market header 27 and the price axis 15 typically remain stationary with respect to the tab page. The cells of the grid 21 and their associated gridlines may move as if the grid is a window and being moved as such, or the cells and gridlines may appear stationary on the grid and only the text labels and visual indications of trading activity appear to move. Such is the case in spreadsheet programs such as Excel in which the column and row headers, and the cells appear stationary while the data or text labels inside the cells move in row and column increments. Typically, such graphical options including the handgrab options are configurable by the user.

The handgrab functionality may also be used to move the grid left or right if applicable. For example, when multiple markets are quoted, and each market is in their respective column, or when the grid or tab page panel width is constrained by other tabsets being present on the interface.

It should be understood that the grid may also be moved left and right by horizontal and vertical scroll bars that may appear adjacent to the grid (if such scroll bars are needed depending on the extent of the data available or configured for the grid). Generally, the handgrab feature will disable the scroll bars to maximize the visible grid area.

The price axis may also be centered relative to trading activity by pressing a centering button on the grid, or accessing such a feature through the menu bar, the tool bar, the grid, the tab page, or using a right-click, mousewheel, or programmable button on a mouse. Similarly, the price axis can be centered with respect to trading activity or some other parameter such as the mid-point spread, the last trade price, the midpoint trading range, and the like by double-clicking on the price axis itself.

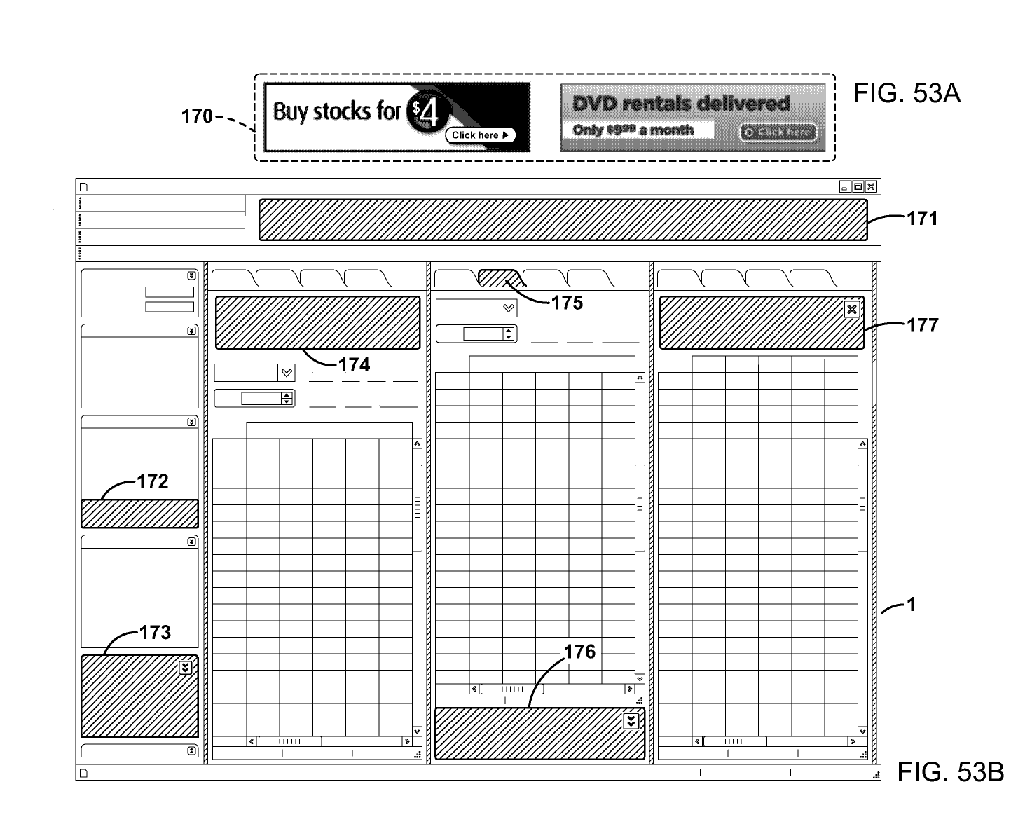

FIG. 53A shows an example of advertisements that are typically displayed to users of software applications that are configured to receive advertisements. FIG. 53B shows the main window 1 of a trading interface with specific areas highlighted to indicate where advertisements may be displayed. It is to be noted however that online advertisements can also be shown in other areas of the trading interface.

As shown in FIG. 53B, advertisement can be displayed in a toolbar 171, in its own panel 173, in the lower part of a panel 172, in a tab 175, in the top part 174 above the level 1 information display of a trading grid, in the lower part 176 below the grid proper of a trading grid, or the top part 177 of a trading grid with the level 1 information display hidden.

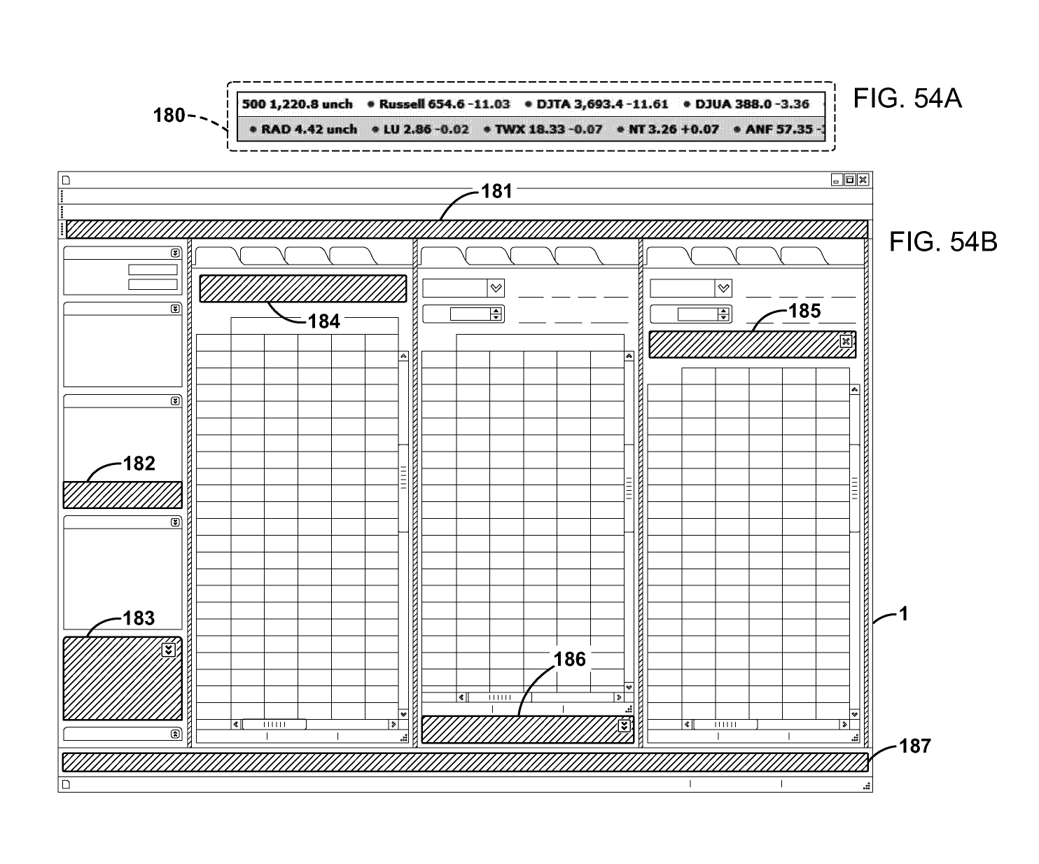

FIG. 54A shows an example of a scrolling ticker 180 that displays trading-related information. FIG. 54B shows the main window 1 of a trading interface with specific areas highlighted to indicate where scrolling tickers that show trading-related information may be displayed. It is to be noted however that scrolling tickers can also be shown in other areas of the trading interface.

As shown in FIG. 54B, advertisement can be displayed in a toolbar 181, in its own panel 183, in the lower part of a panel 182, in the top part 184 of a trading grid with the level 1 information display hidden, in the top part 185 below the level 1 information display of a trading grid, in the lower part 186 below the grid proper of a trading grid, or in a panel 187 that is docked at the bottom of the trading interface.

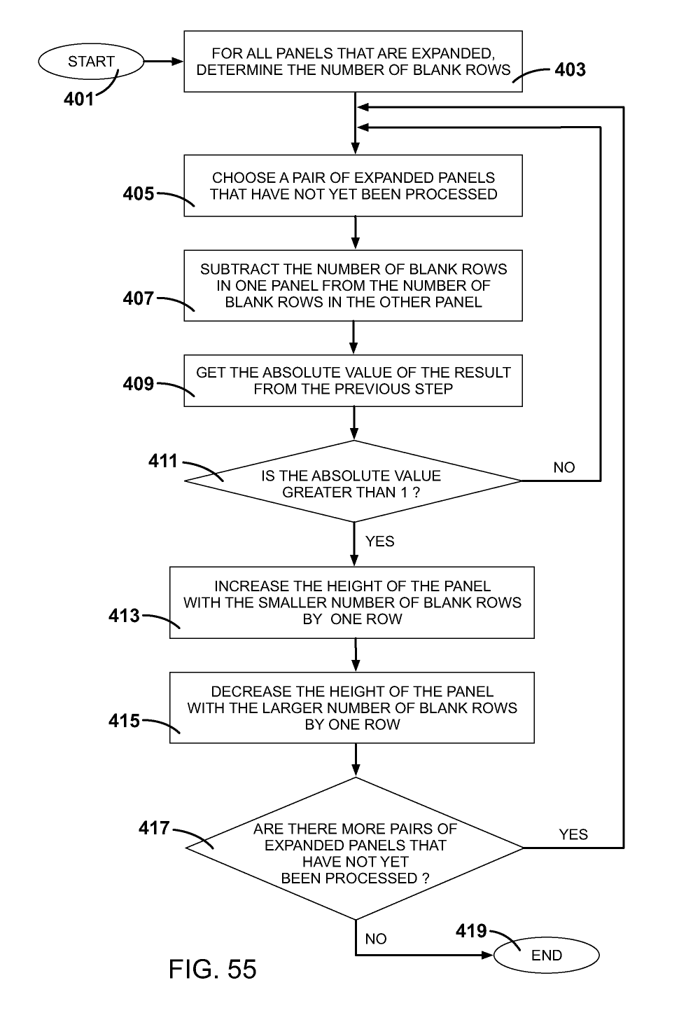

FIG. 55 shows a flowchart depicting an algorithm for implementing the icon packing feature in a software application such as the trading interface of the present invention. Note that other algorithms for implementing icon packing may also be used, without departing from the basic concepts of the icon packing feature. The flowchart comprises the following steps:

The Start step 401 represents the starting point of the algorithm. The For All Panels That Are Expanded, Determine The Number Of Blank Rows step 403 involves looping though all expanded panels and computing the number of blank rows for each expanded panel. The Choose A Pair Of Expanded Panels That Have Not Yet Been Processed step 405 involves selecting two expanded panels that have not yet been processed by the algorithm. The Subtract The Number Of Blank Rows In One Panel From The Number Of Blank Rows In The Other Panel step 407 involves computing the difference between the number of blank rows in one panel from the number of blank rows in the other panel. The Get The Absolute Value Of the Result From the Previous Step step 409 involves determining the absolute value of the difference computed in the Subtract The Number Of Blank Rows In One Panel From The Number Of Blank Rows In The Other Panel step 407.

The Is The Absolute Value is Greater Than 1? step 411 represents a decision point. If the result of the decision is No, the algorithm goes back to the Choose A Pair Of Expanded Panels That Have Not Yet Been Processed step 405. If the result of the decision is Yes, the algorithm proceeds to the Increase The Height Of the Panel With The Smaller Number Of Blank Rows By One Row step 413.

The Increase The Height Of the Panel With The Smaller Number Of Blank Rows By One Row step 413 involves increasing the height of the of the panel with the smaller number of rows to accommodate one additional row. The Decrease The Height Of the Panel With The Larger Number Of Blank Rows By One Row step 415 involves decreasing the height of the of the panel with the larger number of rows to remove one row.

The Are There More Pairs Of Expanded Panels That Have Not Yet Been Processed? step 417 represents a decision point that checks whether there are still pairs of expanded panels that have not yet been processed. If the result of the decision is Yes, the algorithm goes back to the Choose A Pair Of Expanded Panels That Have Not Yet Been Processed step 405. If the result of the decision is No, the algorithm goes to the End step 419. The End step 419 represents the end point of the algorithm.

FIG. 56 displays a table 370 showing how icon size in the status panels 380 may be proportional to a parameter of the security or trade. The security is shown in column 371. For example, the icon size of each holdings or of each open, filled, or cancelled order may vary according to the share quantity of the underlying trade 373, the dollar value of the trade 374, an average of the dollar value and share quantity sizes, the underlying share price 372, and the like.

FIG. 47B is based on the varying relative icon area shown in the quantity column 377 of FIG. 56. For example, the relative icon size of the holdings icons for HP 140 and DELL 141 in the holdings status panel 2 of FIG. 47B is shown in the HP row 382 and the DELL row 384 of Table 370 in FIG. 56. The relative icon sizes of HP 140 and DELL 141 seen in FIG. 47B is proportional to the share quantity of each holdings and the actual icon unit size is shown in data area 385 of table 370 of FIG. 56. The icon unit size shown in columns 377, 378, 379, and 381 valued may be adjusted to LOG or LN values in there are significant proportional differences between the trades or holdings of different securities.

The relative icon area reference 376 may also be related to the dollar value column 378, an average of the dollar value and the quantity columns 379, and the share price column 381. The relative size the status icons shown in columns 377, 378, 379, and 381 may be related to the default icon size shown in column 375.

Cells on the grid may show data associated with a given value or range of values. Typically, the data displayed within a cell is associated with one or more specific securities, one or more specific markets, one or more specific order types (such as a buy, sell, or short order), and a specific price or interval of prices. Generally, each cell on the grid represents a distinct price or range of prices for a given market and security. Typically, the price difference between adjacent sequential cells is the MPV or minimum price variance of the traded security. The user may adjust the price interval of each cell manually, or the interface may do so automatically according to the underlying price of the security, the activity and volatility of the trading activity, and the like. The actual cell price interval chosen may also vary by country and currency.

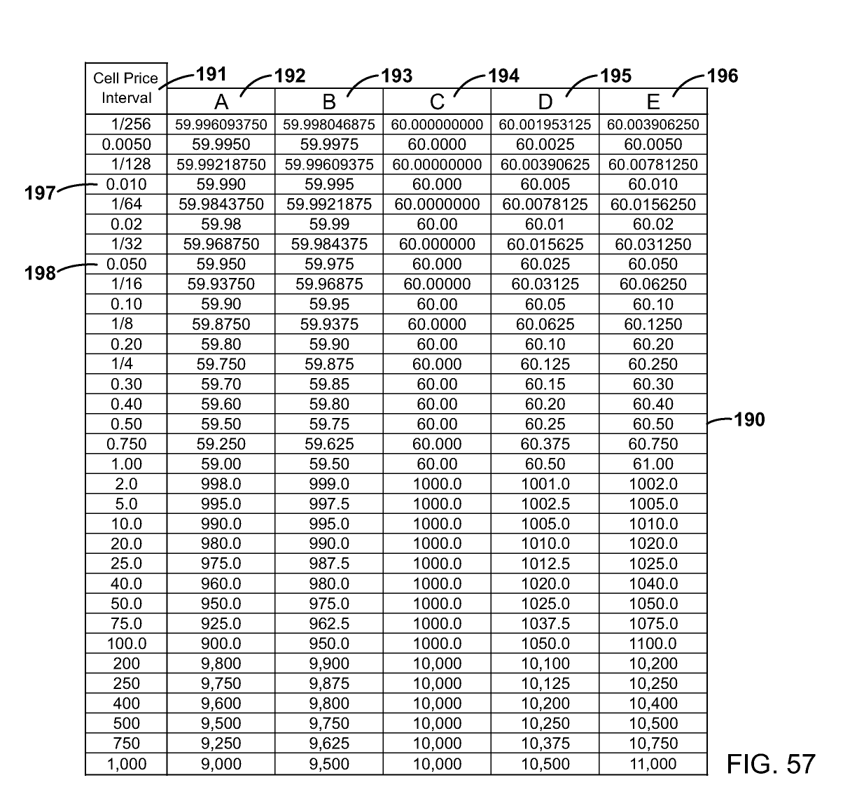

FIG. 57 shows a table 190 with examples of the cell price interval and cell price range options associated with a given cell on the grid. The Cell Price Interval column 191 represents the typical price intervals available to the system. Column C 194 represents the nominal (or displayed) price text label (if the price text label is enabled) for a cell. The values in the columns A 192, B 193, C 194, D 195, E 196 are for illustrative purposes. Given a 0.010 cell price interval as shown at row 197, the user may choose from the following price interval ranges referenced by column header: [C, E), [B, D), (B, D], or (A, C]. The actual values are in row 197. Similarly, if the user chooses a 0.050 cell price interval at row 198, the interval will expand as shown along row 198 for each price interval range referenced by column header: [C, E), [B, D), (B, D], or (A, C]. Referring to FIG. 57, it can be seen that the number of cells required to display a given range of security prices depends on the user to some extent. The user can choose to view a $1.00 trading range on the grid as 100 cells as shown at 197 on table 190) or as 20 cells (as shown at 198 on table 190), or as some other cell price interval.

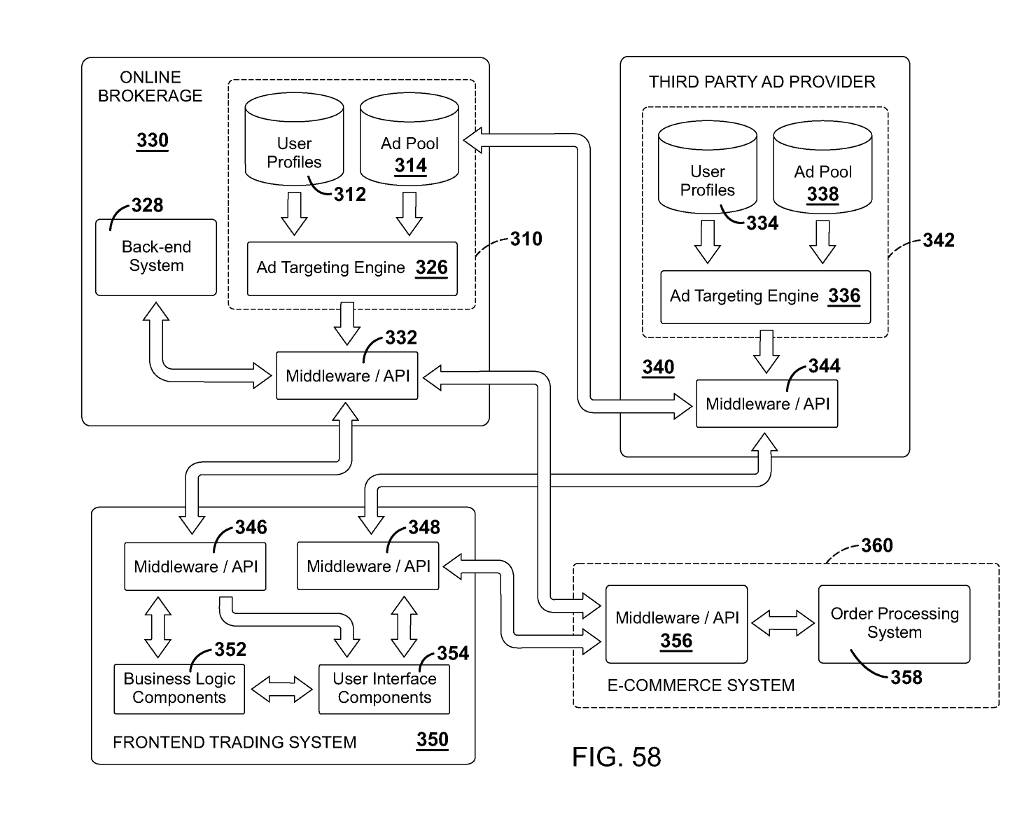

FIG. 58 shows the architecture of an Advertisement Targeting System for online trading. An Online Brokerage 330 can operate an Advertisement Targeting System 310 to deliver targeted advertisements to its customers via the Front-end Trading System 350 used by the customers of the Online Brokerage 330. The Advertisement Targeting System 310 is typically distinct from the Online Brokerage's 330 Back-end System 328, which is typically responsible for processing transactions, delivering quote feeds, and other related functionality.

The targeted advertisements produced by the Advertisement Targeting System 310 are typically delivered to the Front-end Trading System 350 using a middleware Application Programming Interface (API) whose components are shared by the Back-end System 328, the Advertisement Targeting System 310, and the Front-end Trading System 350. The middleware API 332 which is installed close to the Back-end System 328, and the middleware API 346 which is installed with the Front-end Trading System 350 typically implement optimized functions for delivering targeted advertisements to the Front-end Trading System 350.

The Online Brokerage 330 maintains a User Profiles 312 database containing detailed information about its customers. The Online Brokerage 330 also maintains an Ad (i.e. Advertisements) Pool 314 containing advertisements that are generated in-house, and advertisements that are outsourced from third party companies such as Third Party Ad Provider 340. The User Profiles 312 database and the Ad Pool 314 are inputs to the Advertisement Targeting Engine 326, which implements the logic for selecting advertisements that closely match the interests of a given user.

The Online Brokerage 330 may grant permission to a Third Party Ad Provider 340 to deliver targeted advertisements directly to the Online Brokerage's 330 customers. The Third Party Ad Provider 340 typically operates its own Advertisement Targeting System 342. To facilitate the delivery of targeted advertisements, the Third Party Ad Provider 340 typically employs middleware API 344 which is installed close to the Advertisement Targeting System 342 and middleware API 348 which is installed with the Front-end Trading System 350. The middleware API 344 and middleware API 348 ensure data compatibility between the data format used by the Third Party Ad Provider 340 and the data format that is understood by the Front-end Trading System 350.

The Third Party Ad Provider 340 typically maintains its own Ad Pool 338 and it may also maintain its own User Profiles 334 database. The Third Party Ad Provider 340 typically does not have detailed profile information about the Online Brokerage's 330 customers, as a result the advertisements that the Third Party Ad Provider 340 delivers directly to the Online Brokerage's 330 customers may not accurately match the customers' interests. The User Profiles 334 database and the Ad Pool 338 are inputs to the Ad Targeting Engine 336, which implement the logic for selecting advertisements that closely match the interests of users.

The Third Party Ad Provider 340 may also deliver targeted advertisements to the Online Brokerage 330 for redistribution by the latter to its customers. In this scenario, the Online Brokerage 330 uses the Third Party Ad Provider 340′s middleware API 344 to receive advertisements which the Online Brokerage 330 may then store in its Ad Pool 314.

The targeted advertisements delivered by the Online Brokerage 330 and/or Third Party Ad Provider 340 to the Front-end Trading System 350 are typically displayed to the user using suitable user interface technologies such as HTML, Macromedia™ Flash, Portable Document Format (PDF), and the like. The User Interface Components 354 that are installed with the Front-end Trading System 350 are responsible for displaying the targeted advertisements to the user. The User Interface Components 354 are distinct from the Business Logic Components 352 that handle the business-related functionalities of the Front-end Trading System 350. The User Interface Components 354 and the Business Logic Components 352 typically capture statistical data pertaining to the display of the advertisement, such as the time the user spends viewing an advertisement, the time it takes to browse through a list of advertisements, the time it takes for the user to purchase the advertised product or service, and other related metrics. The User Interface Components 354 typically communicates the statistical data that it captures to the Back-end System 328, using middleware API 346 and middleware API 332.

When the user of the Front-end Trading System 350 responds to a targeted advertisement by executing an action such as clicking on the Uniform Resource Locator (URL) associated with the targeted advertisement, the user is typically directed to an E-Commerce System 360, which is a system that facilitates the online purchase of products and services. The E-Commerce System 360 may be operated by the Online Brokerage 330, or the E-Commerce System 360 may be operated by a third party company, for example the seller or provider of the product or service being advertised. The E-Commerce System 360 typically employs a middleware API 356 to facilitate communication with the Front-end Trading System 350 and the Back-end System 328 operated by the Online Brokerage 330. The Order Processing System 358 is responsible for processing the purchase transactions that may be initiated by users of the Front-end Trading System 350. Typically, the Back-end System 328, the Business Logic Components 352, the User Interface Components 354, the Order Processing 358, and the various middleware API's work together to facilitate purchase transactions, to perform business-related auditing, to gather statistical information about the purchasing behavior of users, and to perform other related functions.

FIG. 59 shows the internal structure of the Advertisement Targeting System. The Advertisement Targeting System 310 typically uses a User Profiles 312 database and an Ad Pool 314 as inputs. The User Profiles 312 database contains detailed information about users and their respective interests/preferences, demographics, purchasing history, and any other information that the owner of the Advertisement Targeting System 310 consider relevant. A data record in the User Profiles 312 database may represent a single person or entity, or a group of persons or entities categorized together based shared characteristics. The Ad Pool 314 is a database of advertisements containing information about the specifications of a product or service, purchasing information, images, referral-tracking information, and other merchandise-related information.

The User Profiles 312 database and the Ad Pool 314 are typically generated and maintained by the owner of the Advertisement Targeting System 310. The owner of the Advertisement Targeting System 310 may also obtain the contents of the User Profiles 312 database and the Ad Pool 314 from third party companies such as market research firms, advertising firms, and the like.

The output of the Advertisement Targeting System 310 is a set of Targeted Ads 324 that match the interests of a given user. The Targeted Ads 324 are typically packaged in a suitable data exchange format, such as XML.

At the core of the Advertisement Targeting System 310 is the Advertisement Targeting Engine 326, which can be visually depicted as a funnel. A large set of potential advertisements retrieved from the Ad Pool 314 are fed to the Advertisement Targeting Engine 326. The Advertisement Targeting Engine 326 gradually narrows down the set of advertisements by applying filtering and scoring rules to the set of advertisements until only a small set of advertisements is left.

The Advertisement Targeting Engine 326 executes the several steps to generate Targeted Ads 324 that match the interests of a given user. The Filtering 316 step quickly removes advertisements from the initial set of potential advertisements. In this step the Advertisement Targeting Engine 326 applies broad rules, for example a date range or demographic criteria such as the gender or age of the target market for the advertisements.

The Scoring 318 step involves the application of computational methods, business rules, and other criteria, to evaluate how closely an advertisement matches the interests of a given user. During this step a score is associated with each advertisement based on the results of the aforementioned computational methods/business rules. An example of a business rule used during this step is the assignment of a higher score to advertisements made by a preferred company.

The Select Winning Ads 320 step involves the application of further business rules against the set of advertisements generated by the previous steps, in order to rank the set of advertisements according to some criteria. An example of a business rule used during this step is to select the top N paid advertisements that maximize profits for the owner of the Advertisement Targeting System 310.

The Record History 322 step involves the recording of the final output of the Advertisement Targeting Engine 326 in the User Profile record of a given user. This information is typically used during subsequent executions of the Advertisement Targeting Engine 326, for example to exclude advertisements that have been previously delivered to a given user.

A tabs based drag and drop graphical trading interface and its system architecture has been described. The software, and particulars of the software, have been described to the extent necessary, it being understood that any person skilled in the art of writing software for the appropriate platform such as ActiveX, Windows, GUI-based systems, and so on, may write specific software, and may provide specific functional and logical architecture, without departing from the spirit and the scope of the appended claims.

Other modifications and alterations may be used in the design and manufacture of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A graphical trading interface comprising of a graphical interface adapted to display market trading data received from at least one market participant, wherein said graphical interface establishes connections with any backend systems used by any market participant through communication channels; wherein said market trading data includes information chosen from the group of market trading data consisting of: order data as to buy, sell, or other trading orders, quote data as to bid and ask prices, volume, market participant identifiers, and other parameters, and wherein said market trading data is transmitted to said graphical interface from said back end system in computer-readable electronic format; wherein said graphical interface includes at least one display panel for graphically presenting market trading data, wherein said market trading data is graphically presented on said at least one display panels; wherein an intended trading order or a trading order is represented on said at least one display panel by a GUI object, wherein said GUI object is selected and positioned over said at least one display panel, by a user of said graphical interface, using pointing and positioning means for pointing and positioning a GUI object on said graphical interface; wherein the act of selecting and positioning said GUI object representing said trading order, over said at least one display panel, effects order placement or order modification instructions, and wherein said GUI object has an associated GUI object representing the status of the trading order.

2. The graphical trading interface of claim 1, wherein said GUI object and said associated GUI object may be electively cross referenced to one another.

3. The graphical trading interface of claim 1, wherein advertising content may be displayed within a tab page and on the main window.

4. A graphical trading interface for buying and selling securities wherein there are one or more status icons, wherein each icon represents either an open order, a filled order, or a cancelled order on a first area of said trading interface and one or more GUI objects, wherein each GUI object represents an open order, a filled order, or a cancelled order on an interactive grid or array of adjacent cells on a second area of said trading interface, wherein each cell represents a distinct price, wherein there is a user accessible feature or software control which allows said user of said trading interface to visually cross reference or identify the relationship or association between an icon on said first area with a GUI object on said second area of said trading interface and vice versa.
